(19) United States
(12) Patent Application Publication
(10) Pub. No.: US 2026/0051787 A1
(43) Pub. Date: Feb. 19, 2026

(54) MOTOR UNITS AND WORKING MACHINES

(71) Applicant: MAKITA CORPORATION, Anjo-shi (JP)

(72) Inventors: Hiroki TAKEDA, Anjo-shi (JP); Hajime TAKEUCHI, Anjo-shi (JP); Tomohiro SAEKI, Anjo-shi (JP)

(73) Assignee: MAKITA CORPORATION, Anjo-shi (JP)

(21) Appl. No.: 19/256,910

(22) Filed: Jul. 1, 2025

(30) Foreign Application Priority Data
Aug. 19, 2024 (JP) 2024-137895

(51) Int. Cl. H02K 7/14; B25F 5/02; H02K 11/30

(52) U.S. Cl. CPC H02K 7/145; B25F 5/02; H02K 11/30; H02K 2213/12

(57) ABSTRACT

A motor unit may include an output shaft; an electric motor; a housing; a first battery receptacle disposed on the housing and configured to allow a first battery to be detachably attached thereto; a second battery receptacle disposed on a working unit and configured to allow a second battery to be detachably attached thereto; an adapter attachable to the first battery receptacle in place of the first battery; a cable extending from the adapter and configured to connect to either the second battery receptacle or the second battery; and a control circuit board. When the first battery is attached to the first battery receptacle, power may be supplied from the first battery to the electric motor. When the adapter is attached to the first battery receptacle and the second battery is attached to the second battery receptacle, power may be supplied from the second battery to the electric motor.

### CROSS REFERENCE TO RELATED APPLICATION

This application claims priority to Japanese Patent Application No. 2024-137895 filed on Aug. 19, 2024. The entire content of the priority application is incorporated herein by reference.

### TECHNICAL FIELD

The art disclosed herein relates to motor units and working machines.

### BACKGROUND ART

International Publication No. 2020/049617 describes a motor unit configured to be detachably attached to each of working units of multiple types to drive the working unit. This motor unit includes an output shaft configured to be connected to the working unit, an electric motor configured to rotate the output shaft, a housing that houses the electric motor, a battery receptacle disposed on the housing and configured to allow a battery to be detachably attached thereto, and a control circuit board configured to control an output of the electric motor. When the battery is attached to the battery receptacle, electric power is supplied from the battery to the electric motor via the battery receptacle.

### SUMMARY

In the motor unit of International Publication No. 2020/049617, the battery attached to the battery receptacle is fixed to the housing that houses the electric motor therein. Thus, when the housing is subjected to vibrations caused by the operation of the electric motor, the vibrations may be transmitted to the battery. Here, the vibrations to which the housing is subjected to include, for example, vibrations from the working unit to the housing. The disclosure herein provides a technology for reducing transmission of vibrations from a housing to a battery.

A motor unit may be configured to be detachably attached to each of working units of multiple types to drive the working unit to which the motor unit is attached. The motor unit may comprise an output shaft configured to be connected to the working unit; an electric motor configured to rotate the output shaft; a housing that houses the electric motor; a first battery receptacle disposed on the housing and configured to allow a first battery to be detachably attached thereto; a second battery receptacle disposed on the working unit and configured to allow a second battery to be detachably attached thereto; an adapter configured to be attached to the first battery receptacle in place of the first battery; a cable extending from the adapter and configured to connect to either the second battery receptacle or the second battery; and a control circuit board configured to control an output of the electric motor. When the first battery is attached to the first battery receptacle, power may be supplied from the first battery to the electric motor via the first battery receptacle. When the adapter is attached to the first battery receptacle and the second battery is attached to the second battery receptacle, power may be supplied from the second battery to the electric motor via the cable, the adapter, and the first battery receptacle.

Another motor unit may be configured to be detachably attached to each of working units of multiple types to drive the working unit to which the motor unit is attached. The motor unit may comprise an output shaft configured to be connected to the working unit; an electric motor configured to rotate the output shaft; a housing that houses the electric motor; a battery receptacle disposed on the working unit and configured to allow a battery to be detachably attached thereto; a cable extending from the housing and configured to connect to either the battery receptacle or the battery; and a control circuit board disposed in the housing and configured to control an output of the electric motor. When the battery is attached to the battery receptacle, power may be supplied from the battery to the electric motor via the cable.

### BRIEF DESCRIPTION OF DRAWINGS

FIG. 1 illustrates a working machine according to a first embodiment as viewed from the upper front left side.

FIG. 2 illustrates a rammer 4a according to the first embodiment as viewed from the upper rear left side.

FIG. 3 illustrates a battery pack BP according to the first embodiment.

FIG. 4 illustrates how the battery pack BP according to the first embodiment is attached to and used in an electric tool T.

FIG. 5 illustrates a motor unit 2 according to the first embodiment as viewed from the upper rear left side.

FIG. 6 illustrates the motor unit 2 according to the first embodiment as viewed from the lower front right side.

FIG. 7 illustrates a cross-sectional left side view of the motor unit 2 according to the first embodiment, showing the interior of the motor unit 2.

FIG. 8 illustrates the motor unit 2 according to the first embodiment as viewed from the upper rear left side, with adapters 82 attached thereto.

FIG. 9 illustrates the rammer 4a as viewed from the upper rear left side, with a cover 96 of a second battery receptacle 90a according to the first embodiment being in an open state.

FIG. 10 illustrates a body 94 of the second battery receptacle 90a according to the first embodiment as viewed from the upper rear left side of the rammer 4a.

FIG. 11 illustrates a working machine according to a second embodiment as viewed from the upper front left side.

FIG. 12 illustrates a battery device BD according to the second embodiment.

FIG. 13 illustrates a second battery receptacle 204a according to the second embodiment.

FIG. 14 illustrates a block diagram showing a flow of power transmission in the working machines according to the first and second embodiments.

FIG. 15 illustrates a working machine according to a third embodiment as viewed from the upper front left side.

FIG. 16 illustrates a working machine according to a fourth embodiment as viewed from the upper front left side.

FIG. 17 illustrates a block diagram showing a flow of power transmission in the working machines according to the third and fourth embodiments.

FIG. 18 illustrates a working machine according to a fifth embodiment as viewed from the upper front right side.

FIG. 19 illustrates a working machine according to a sixth embodiment as viewed from the upper front right side.

FIG. 20 illustrates a block diagram showing a flow of power transmission in the working machines according to the fifth and sixth embodiments.

FIG. 21 illustrates a working machine according to a seventh embodiment as viewed from the upper front right side.

FIG. 22 illustrates a working machine according to an eighth embodiment as viewed from the upper front right side.

FIG. 23 illustrates a block diagram showing a flow of power transmission in the working machines according to the seventh and eighth embodiments.

FIG. 24 illustrates a working machine according to a ninth embodiment as viewed from the upper front right side.

FIG. 25 illustrates a working machine according to a tenth embodiment as viewed from the upper front right side.

FIG. 26 illustrates a block diagram showing a flow of power transmission in the working machines according to the ninth and tenth embodiments.

FIG. 27 illustrates a working machine according to an eleventh embodiment as viewed from the upper front right side.

FIG. 28 illustrates a working machine according to a twelfth embodiment as viewed from the upper front right side.

FIG. 29 illustrates a block diagram showing a flow of power transmission in the working machines according to the eleventh and twelfth embodiments.

FIG. 30 illustrates a working machine according to a thirteenth embodiment as viewed from the upper left side.

FIG. 31 illustrates a working machine according to a fourteenth embodiment as viewed from the upper left side.

FIG. 32 illustrates a block diagram showing a flow of power transmission in the working machines according to the thirteenth and fourteenth embodiments.

FIG. 33 illustrates a working machine according to a fifteenth embodiment as viewed from the upper front right side.

FIG. 34 illustrates a working machine according to a sixteenth embodiment as viewed from the upper front right side.

FIG. 35 illustrates a block diagram showing a flow of power transmission in the working machines according to the fifteenth and sixteenth embodiments.

FIG. 36 illustrates a working machine according to a seventeenth embodiment as viewed from the upper front left side.

FIG. 37 illustrates a working machine according to an eighteenth embodiment as viewed from the upper front left side.

FIG. 38 illustrates a block diagram showing a flow of power transmission in the working machines according to the seventeenth and eighteenth embodiments.

### DETAILED DESCRIPTION

In one embodiment of the present teachings, a motor unit may be configured to be detachably attached to each of working units of multiple types to drive the working unit to which the motor unit is attached. The motor unit may comprise an output shaft configured to be connected to the working unit; an electric motor configured to rotate the output shaft; a housing that houses the electric motor; a first battery receptacle disposed on the housing and configured to allow a first battery to be detachably attached thereto; a second battery receptacle disposed on the working unit and configured to allow a second battery to be detachably attached thereto; an adapter configured to be attached to the first battery receptacle in place of the first battery; a cable extending from the adapter and configured to connect to either the second battery receptacle or the second battery; and a control circuit board configured to control an output of the electric motor. When the first battery is attached to the first battery receptacle, power may be supplied from the first battery to the electric motor via the first battery receptacle. When the adapter is attached to the first battery receptacle and the second battery is attached to the second battery receptacle, power may be supplied from the second battery to the electric motor via the cable, the adapter, and the first battery receptacle.

In the configuration above, the battery can be attached to the second battery receptacle disposed on the working unit. Attaching the battery to the second battery receptacle reduces transmission of vibrations from the housing to the battery, compared to attaching the battery to the housing.

In one embodiment of the present teachings, another motor unit may be configured to be detachably attached to each of working units of multiple types to drive the working unit to which the motor unit is attached. The motor unit may comprise an output shaft configured to be connected to the working unit; an electric motor configured to rotate the output shaft; a housing that houses the electric motor; a battery receptacle disposed on the working unit and configured to allow a battery to be detachably attached thereto; a cable extending from the housing and configured to connect to either the battery receptacle or the battery; and a control circuit board disposed in the housing and configured to control an output of the electric motor. When the battery is attached to the battery receptacle, power may be supplied from the battery to the electric motor via the cable.

In the configuration above, the battery can be attached to the battery receptacle disposed on the working unit. Attaching the battery to the battery receptacle reduces the transmission of vibrations from the housing to the battery, compared to attaching the battery to the housing.

In one embodiment of the present teachings, the control circuit board may be disposed in the housing.

A fan for cooling the electric motor may be disposed in the housing. In the configuration above, the control circuit board as well as the electric motor can be cooled with cooling airflow generated by the fan. Thus, another fan for cooling the control circuit board is not required to be disposed in the motor unit, which allows for simplification of the configuration of the motor unit.

In one embodiment of the present teachings, the motor unit may further comprise a first surface parallel to an axial direction of the output shaft and a second surface perpendicular to the axial direction of the output shaft. The motor unit may be configured to be fixed to the working unit with at least one of the first surface and the second surface in contact with the working unit.

In the configuration above, the motor unit can be attached to the working units in various orientations (e.g., with the first surface in contact with the working unit, with the second surface in contact with the working unit, etc.). This leads to an increase in the number of types of working units to which the motor unit is attachable.

In one embodiment of the present teachings, at least one of the first battery and the second battery may be capable of supplying power to an electric device different from the motor unit when the at least one of the first battery and the second battery is detached from the motor unit and attached to the electric device.

The above configuration allows the at least one battery to be used not only in the motor unit but also in the electric device different from the motor unit.

In one embodiment of the present teachings, the second battery may comprise a plurality of second batteries. The plurality of second batteries may include a plurality of battery packs. The second battery receptacle may be configured to allow the plurality of battery packs to be detachably attached thereto.

Since the plurality of battery packs can be attached to the second battery receptacle in the configuration above, the electric motor can operate using the power from the plurality of battery packs. This allows for an increase in the output of the electric motor, for example, compared to the electric motor operating using the power from a single battery pack. Thus, the motor unit can be used with working units that require high outputs. That is, the above configuration allows for an increase in the number of types of working units to which the motor unit is applicable.

In one embodiment of the present teachings, the second battery may include a battery pack. The motor unit may further comprise a cover that covers the battery pack attached to the second battery receptacle.

The configuration above protects the battery pack attached to the second battery receptacle against external water and dust.

In one embodiment of the present teachings, the working unit may comprise a handle including a grip configured to be grasped by a user. The second battery receptacle may be disposed on the handle.

In the configuration above, the second battery receptacle is disposed on the handle. The handle may be configured to reduce transmission of vibrations from the body of a working unit in order not to make a user gripping the grip uncomfortable. Thus, attaching the battery to the second battery receptacle reduces transmission of vibrations from the body of the working unit to the battery. Further, in the configuration above, the second battery receptacle is disposed at a position easily accessible by the user. This allows the user to easily attach the battery to and detach the battery from the second battery receptacle.

In one embodiment of the present teachings, the second battery receptacle may be on an upper surface of the working unit when the working unit is in a working orientation.

In the configuration above, the second battery receptacle is at a position easily accessible by the user when the working unit is in a working orientation. This allows the user to easily attach the battery to and detach the battery from the second battery receptacle.

In one embodiment of the present teachings, the first battery receptacle and the second battery receptacle may comprise common members, respectively, and the common members may have a common shape to each other.

The configuration above allows common components to be used in the first and second battery receptacles. This allows for a reduction in the manufacturing cost of the motor unit.

In one embodiment of the present teachings, a length of the cable may be in a range of 100 mm to 2000 mm. For example, the length of the cable may be in a range of 1000 mm to 2000 mm, a range of 1300 mm to 2000 mm, a range of 1000 mm to 1500 mm, or a range of 1300 mm to 1500 mm.

The cable extends between the first battery receptacle disposed on the housing and the second battery receptacle disposed on the working unit. If the length of the cable were too long relative to the distance between the first and second battery receptacles, the cable would sag too much and get in the way during use. Although the distance between the first and second battery receptacles differs depending on the type of working unit, it is generally expected to be in a range of 50 mm to 1500 mm. In the configuration above, the length of the cable is only slightly larger than the expected distance between the first and second battery receptacles. Thus, the configuration above prevents the cable from sagging too much and thus prevents the cable from getting in the way during use.

In one embodiment of the present teachings, the adapter may be configured to be detachably attached to the first battery receptacle.

If the adapter were configured to be attached to the first battery receptacle in an undetachable manner, the adapter cannot be detached from the first battery receptacle once attached thereto. However, the user may wish to detach the adapter from the first battery receptacle after having attached it to the first battery receptacle. For example, the user may wish so when wishing to attach the first battery to the first battery receptacle instead of the adapter. In the configuration above, the adapter is detachably attachable to the first battery receptacle. Thus, the adapter can be detached from the first battery receptacle after having been attached to the first battery receptacle. Therefore, the first battery can be attached to the first battery receptacle instead of the adapter.

In one embodiment of the present teachings, the working unit may function as a rammer configured to ram a ground. The working unit may comprise a handle including a grip configured to be grasped by a user. The second battery receptacle may be disposed on the handle.

In the configuration above, the battery is attached to the handle of the rammer. This reduces transmission of vibrations from the housing to the battery and also reduces transmission of vibrations from the body of the rammer to the battery.

In one embodiment of the present teachings, the working unit may function as a plate compactor configured to compact a ground. The working unit may comprise a handle including a grip configured to be grasped by a user. The second battery receptacle may be disposed on the handle.

In the configuration above, the battery is attached to the handle of the plate compactor. This reduces transmission of vibrations from the housing to the battery and also reduces transmission of vibrations from the body of the plate compactor to the battery.

In one embodiment of the present teachings, the working unit may function as a trowel configured to level a concrete surface. The working unit may comprise a handle including a grip configured to be grasped by a user. The second battery receptacle may be disposed on the handle.

In the configuration above, the battery is attached to the handle of the trowel. This reduces transmission of vibrations from the housing to the battery and also reduces transmission of vibrations from the body of the trowel to the battery.

In one embodiment of the present teachings, the working unit may function as a concrete mixer configured to mix concrete. The working unit may comprise a handle including a grip configured to be grasped by a user. The second battery receptacle may be disposed on the handle.

In the configuration above, the battery is attached to the handle of the concrete mixer. This reduces transmission of vibrations from the housing to the battery and also reduces transmission of vibrations from the body of the concrete mixer to the battery.

In one embodiment of the present teachings, the working unit may function as a concrete saw configured to make a cut in concrete. The working unit may comprise a handle including a grip configured to be grasped by a user. The second battery receptacle may be disposed on the handle.

In the configuration above, the battery is attached to the handle of the concrete saw. This reduces transmission of vibrations from the housing to the battery and also reduces transmission of vibrations from the body of the concrete saw to the battery.

In one embodiment of the present teachings, the working unit may function as an injector configured to boost a pressure of a liquid and inject the liquid. The second battery receptacle may be on an upper surface of the working unit when the working unit is in a working orientation.

In the configuration above, the battery is attached to the upper surface of the injector. This reduces transmission of vibrations from the housing to the battery.

In one embodiment of the present teachings, the working unit may function as a mower. The working unit may comprise a handle including a grip configured to be grasped by a user. The second battery receptacle may be disposed on the handle.

In the configuration above, the battery is attached to the handle of the mower. This reduces transmission of vibrations from the housing to the battery and also reduces transmission of vibrations from the body of the mower to the battery.

In one embodiment of the present teachings, a working machine may comprise a working unit and a motor unit configured to be detachably attached to the working unit to drive the working unit.

The configuration above provides the working machine that reduces transmission of vibrations from the housing to the battery.

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved motor units and working machines, as well as methods for using and manufacturing the same.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### First Embodiment

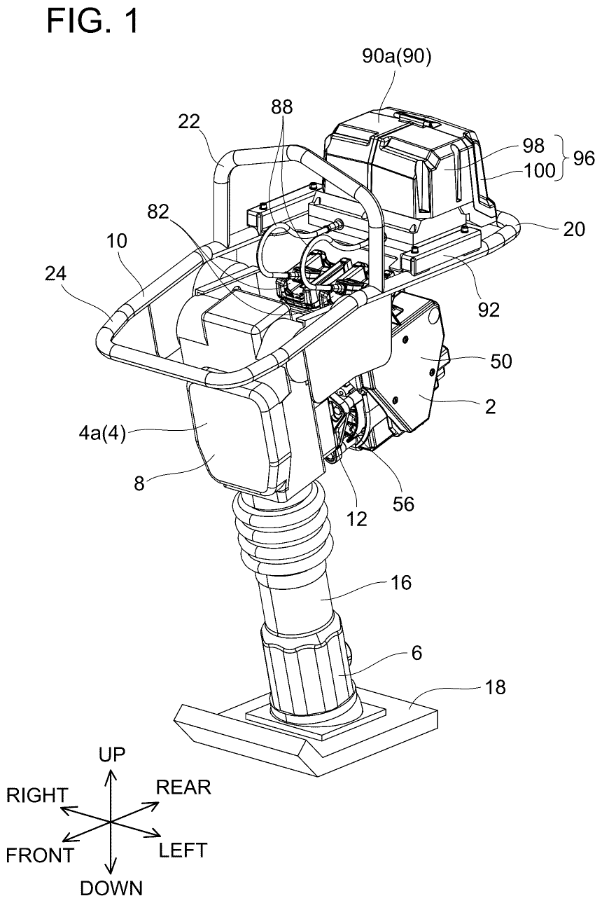

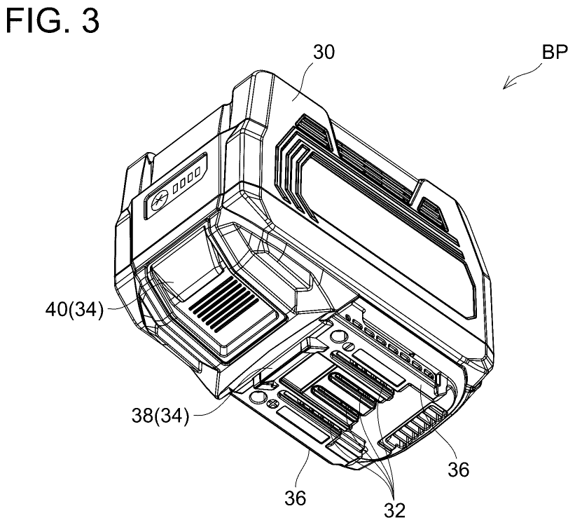

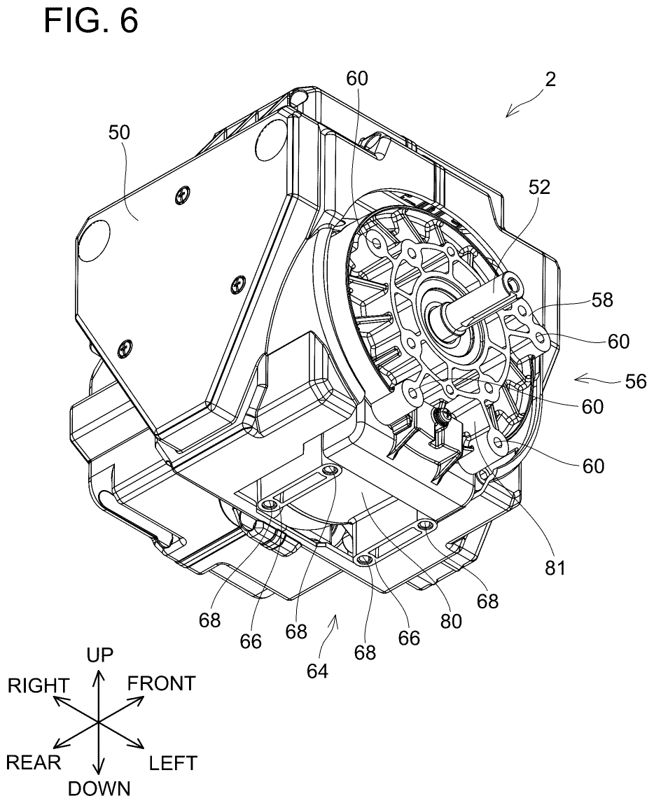

A working machine shown in FIG. 1 comprises a motor unit 2 and a working unit 4 (which is a rammer 4a in this embodiment). The motor unit 2 is configured to be detachably attached to the working unit 4. The motor unit 2 is a prime mover configured to rotate an output shaft 52 (see FIG. 6) using power supplied from a battery pack BP (see FIG. 3) and/or the like. The working unit 4 is a machine member configured to convert the rotational motion of the output shaft 52 to a predetermined motion (e.g., reciprocal motion) to perform work (e.g., ramming the ground). Instead of the motor unit 2, an engine unit (not shown) can be attached to the working unit 4. The engine unit herein may be any engine unit compatible with the motor unit 2, such as an engine unit GX120 from Honda R&D Co., Ltd.

### Configuration of Rammer 4a

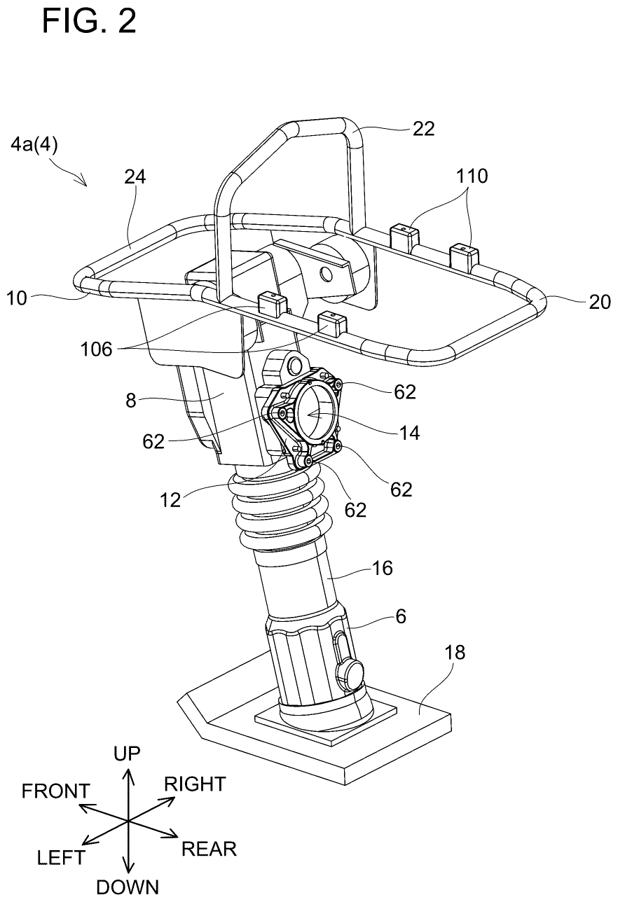

As shown in FIG. 2, the rammer 4a comprises a working part 6 configured to ram the ground, an upper housing 8 supporting the upper portion of the working part 6, and a handle 10 disposed on top of the upper housing 8. The upper housing 8 comprises a mounting base 12 to which the motor unit 2 (see FIG. 1) is attached and an opening 14 for receiving the output shaft 52 (see FIG. 6) of the motor unit 2. The working part 6 comprises an extensible portion 16 extensible in an up-down direction and a ground ramming plate 18 fixed to the lower end of the extensible portion 16. A crank mechanism for converting the rotational motion of the output shaft 52 to a reciprocal motion is housed within the upper housing 8, although this is not shown. The extensible portion 16 extends and contracts in the up-down direction in accordance with the reciprocal motion of the crank mechanism. The rammer 4a extends and contracts the extensible portion 16 in the up-down direction with the ground ramming plate 18 faced toward the ground, so that the ground ramming plate 18 is repeatedly pressed against the ground. The rammer 4a rams the ground in this way. In this embodiment, a front-rear direction, up-down direction, and right-left direction of the rammer 4a are defined based on the vertical direction of the rammer 4a in its working orientation. Specifically, the vertical direction when the ground ramming plate 18 is placed on a horizontal surface is defined as the up-down direction of the rammer 4a, a direction that is perpendicular to the up-down direction and the mounting base 12 faces is defined as the rear direction, the opposite direction to the rear direction is defined as the front direction, and a direction perpendicular to both the front-rear direction and the up-down direction is defined as the right-left direction.

The handle 10 comprises a first grip 20, a second grip 22, and a third grip 24. The first grip 20 extends rearward from the upper end of the upper housing 8, bends and extends rightward, and then bends and extends forward. The second grip 22 extends upward from the upper end of the upper housing 8, bends and extends rightward, and then bends and extends downward. The third grip 24 extends forward and downward from the upper end of the upper housing 8, bends and extends rightward, and then bends and extends rearward and upward. The first grip 20, the second grip 22, and the third grip 24 are formed integrally. At least one of the first grip 20, the second grip 22, or the third grip 24 is gripped by a user during use of the rammer 4a.

### Configuration of Battery Pack BP

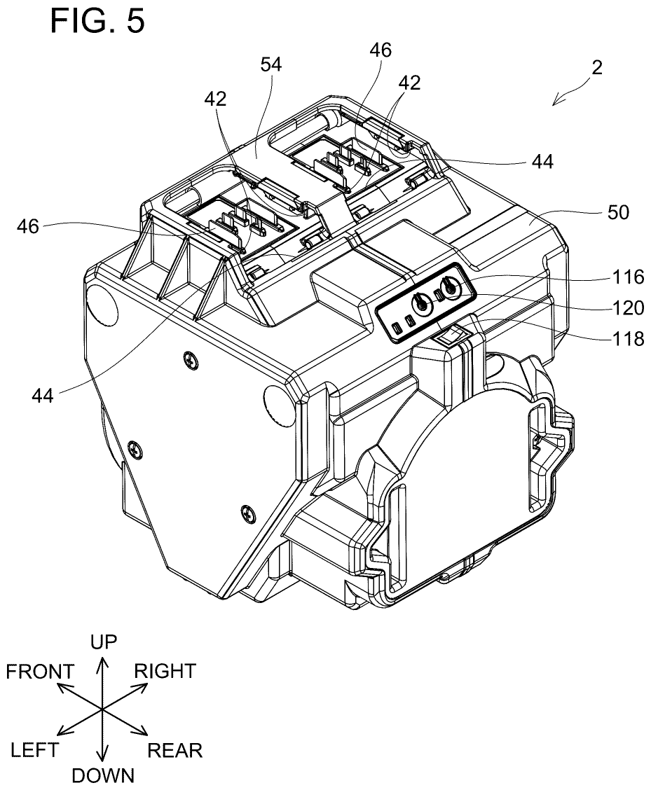

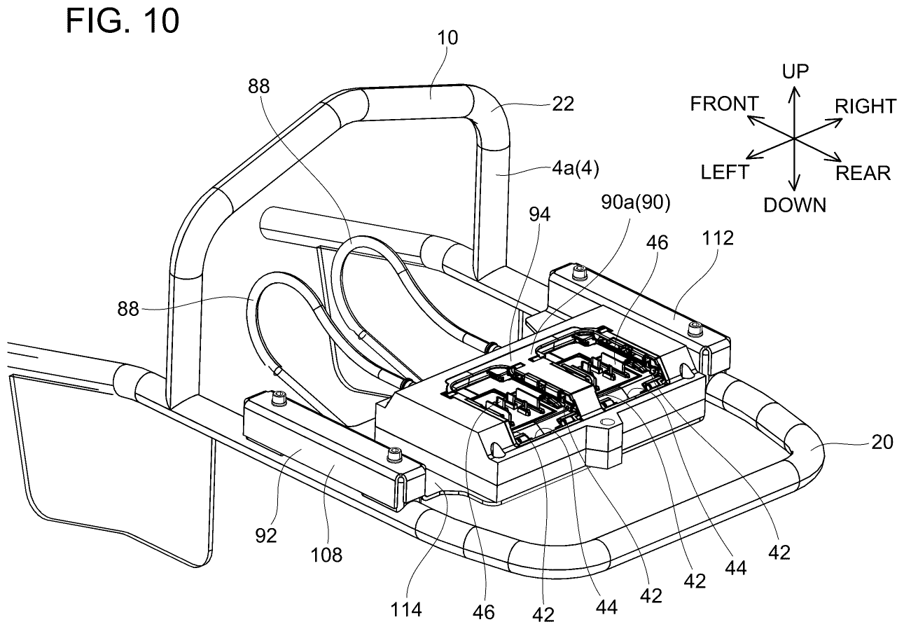

As shown in FIG. 3, the battery pack BP comprises a battery housing 30 configured to house a plurality of rechargeable secondary battery cells (e.g., lithium-ion battery cells) and a hook 34 movably held by the battery housing 30. The hook 34 comprises an engagement portion 38 and a manipulatable portion 40. The engagement portion 38 usually extends out of the battery housing 30. When the manipulatable portion 40 is pushed into the battery housing 30, the engagement portion 38 entirely moves into the battery housing 30. Further, the battery housing 30 defines slits 32 and guide rails 36. The slits 32 communicate the inside of the battery housing 30 with the outside thereof. The slits 32 are formed to be aligned with the positions of battery terminals (not shown) housed in the battery housing 30. The plurality of secondary battery cells is charged and discharged via these battery terminals. The battery pack BP is detachably attachable to battery receptacles 54, 90a (as detailed below, see FIGS. 5 and 10) and supplies power to the motor unit 2 (see FIG. 1).

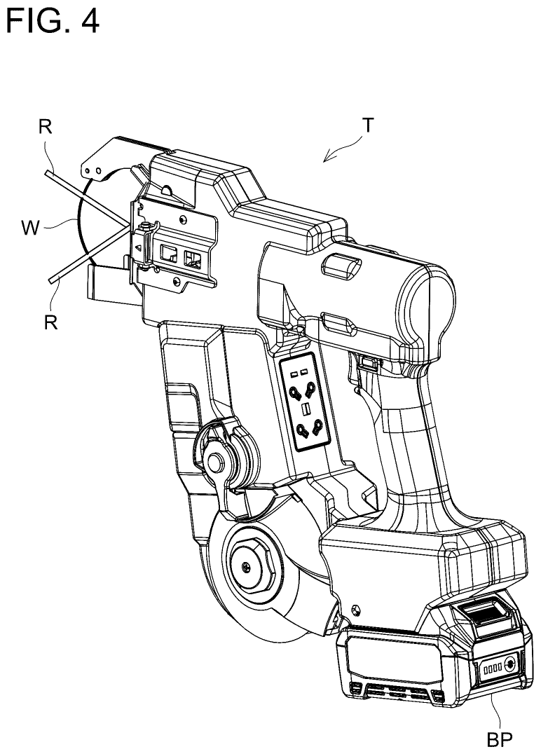

As shown in FIG. 4, the battery pack BP can be detached from the motor unit 2 and attached to an electric tool T to supply power to the electric tool T. The electric tool T is a rebar tying machine configured to tie a plurality of rebars R with a wire W. Similarly, the battery pack BP can also be used with other electric tools T other than the rebar tying machine (e.g., impact drivers, circular saws, driver drills, etc.). The battery pack BP can also be used with gardening equipment (e.g., grass trimmers, blowers, hedge trimmers, chain saws, dollies, snow plows, cultivators, etc.).

### Configuration of Motor Unit 2

As shown in FIGS. 5 and 6, the motor unit 2 comprises a substantially cuboid-shaped housing 50. As shown in FIG. 5, a first battery receptacle 54 is disposed on the upper surface of the housing 50 and configured to allow the battery pack BP (see FIG. 3) to be detachably attached thereto. As shown in FIG. 6, the output shaft 52 projects from the front surface of the housing 50. In this embodiment, independent of the front-rear direction, up-down direction, and right-left direction of the rammer 4a as defined above, a front-rear direction, up-down direction, and right-left direction of the motor unit 2 are defined based on the housing 50. Specifically, the direction in which the output shaft 52 extends is defined as the front-rear direction, the direction in which the output shaft 52 projects from the housing 50 is defined as the front direction, the opposite direction to the front direction is defined as the rear direction, a direction that is perpendicular to the front-rear direction and the first battery receptacle 54 faces is defined as the up direction, the opposite direction to the up direction is defined as the down direction, and a direction perpendicular to the front-rear direction and the up-down direction is defined as the right-left direction. In FIGS. 5, 6, 7, and 8 focusing on the housing 50, the directional indicators are based on the housing 50, while in FIGS. 1, 2, 9, 10, and 11 focusing on the rammer 4a, the directional indicators are based on the rammer 4a.

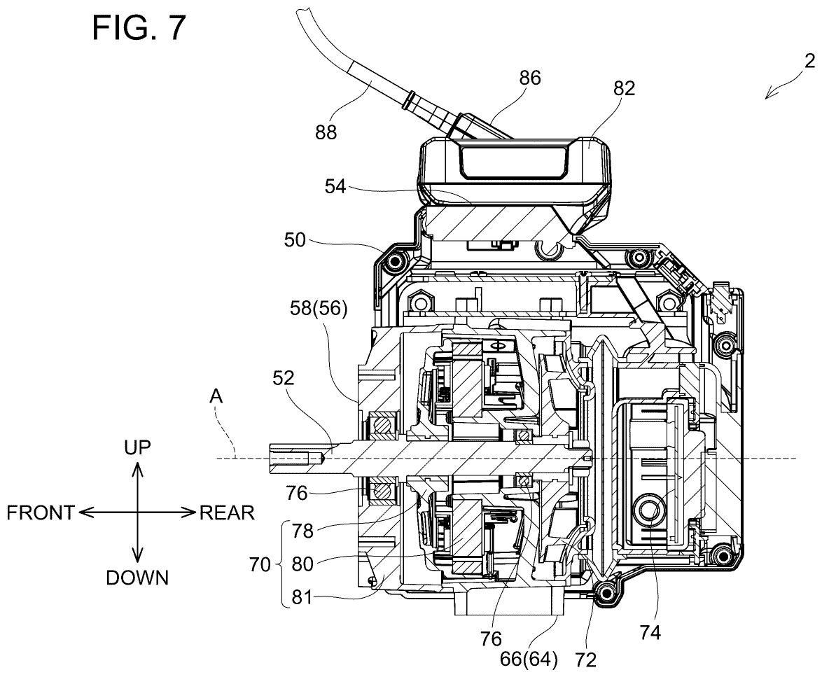

As shown in FIG. 7, the motor unit 2 further comprises an electric motor 70, a fan 72, and a control circuit board 74. The housing 50 houses the electric motor 70, the fan 72, and the control circuit board 74. When the motor unit 2 is attached to the rammer 4a (i.e., in the state shown in FIG. 1), a front portion of the output shaft 52 is inside the upper housing 8 via the opening 14 (see FIG. 2) and coupled to the crank mechanism (not shown) for extending and contracting the extensible portion 16. The electric motor 70 comprises a rotor 78 fixed to the output shaft 52, a stator 80 disposed radially inward of the rotor 78, and a bracket 81 fixed to a front portion of the stator 80. The electric motor 70 is a so-called electric motor of outer rotor type. The stator 80 and the bracket 81 support the output shaft 52 via a bearing 76 such that the output shaft 52 is rotatable about a shaft rotation axis A. The electric motor 70 rotates the output shaft 52 about the shaft rotation axis A. The control circuit board 74 is offset rearward of the rear end of the output shaft 52. The control circuit board 74 is oriented such that its thickness direction coincides with the front-rear direction. The control circuit board 74 is electrically connected to connection terminals 46 (see FIG. 5) of the first battery receptacle 54. The control circuit board 74 adjusts power supplied to the connection terminals 46 and supplies the adjusted power to the electric motor 70. Thus, the control circuit board 74 controls the output of the electric motor 70. The fan 72 is located rearward of the rotor 78 and fixed to the output shaft 52. The fan 72 rotates with the output shaft 52 to generate cooling airflow for cooling the electric motor 70 and the control circuit board 74. The cooling airflow herein refers specifically to an air flow that flows into the housing 50 from the outside of the housing 50, flows between the electric motor 70 and the control circuit board 74, and then flows from the inside of the housing 50 out to the outside of the housing 50. The cooling airflow removes heat generated at each of the electric motor 70 and the control circuit board 74 to the outside of the housing 50.

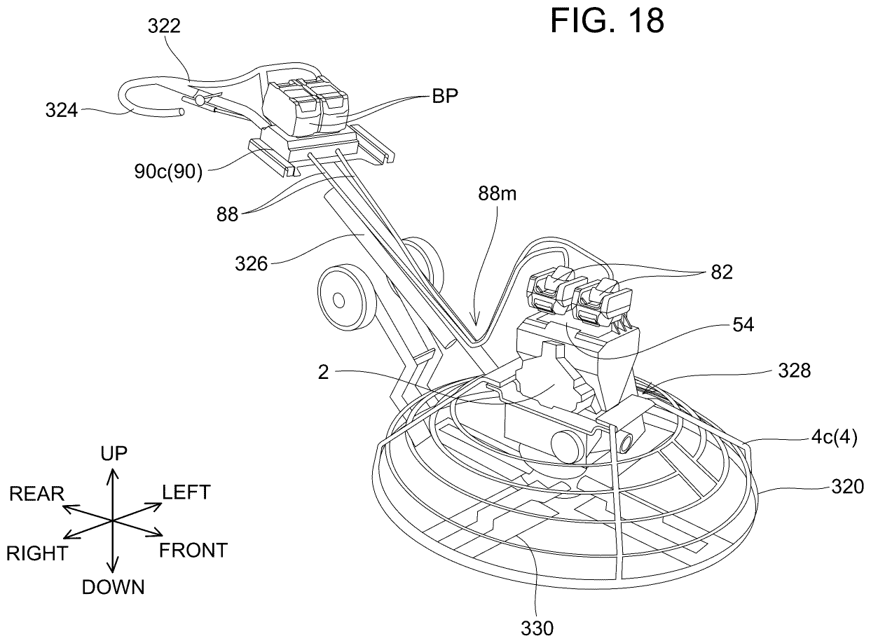

As shown in FIG. 6, a front mounting portion 56 for mounting to the mounting base 12 (see FIG. 2) is disposed on the front surface of the bracket 81. The front mounting portion 56 comprises a front contact surface 58 configured to contact the rear surface of the mounting base 12 and a plurality of screw holes 60. The front contact surface 58 is perpendicular to the axial direction of the output shaft 52. As shown in FIG. 2, the mounting base 12 defines a plurality of through holes 62 positioned to align with the plurality of screw holes 60. By inserting screws into the plurality of through holes 62 and screwing the screws into the plurality of screw holes 60, the motor unit 2 is attached to the rammer 4a with the front contact surface 58 being in contact with the rear surface of the mounting base 12. Further, as shown in FIG. 6, a lower mounting portion 64 is disposed on the lower surface of the stator 80, and the lower mounting portion 64 is for mounting to a different mounting base (e.g., a mounting base 328 (see FIG. 18) to be described below in a fifth embodiment) than the mounting base 12. The lower mounting portion 64 comprises a lower contact surface 66 configured to contact the upper surface of the mounting base and a plurality of screw holes 68. The lower contact surface 66 is parallel to the axial direction of the output shaft 52.

As shown in FIG. 5, the first battery receptacle 54 comprises guide grooves 42 configured to receive the guide rails 36 (see FIG. 3) of each battery pack BP along the front-rear direction in a slidable manner, engagement grooves 44 configured to engage with the engagement portion 38 (see FIG. 3) of the hook 34 of the battery pack BP, and the connection terminals 46 corresponding to battery terminals (not shown) of the battery pack BP.

To attach the battery pack BP to the first battery receptacle 54, the battery pack BP is slid forward toward the first battery receptacle 54. As a result, the guide rails 36 (see FIG. 3) enter the guide grooves 42 and the engagement portion 38 (see FIG. 3) engages with the engagement groove 44, completing the attachment of the battery pack BP. When the battery pack BP is in the attached state to the first battery receptacle 54, the connection terminals 46 are in the inside of the battery housing 30 (see FIG. 3) via the slits 32 (see FIG. 3) and engaged with corresponding battery terminals. Thus, the battery terminals and the connection terminals 46 are electrically connected to each other. To detach the battery pack BP from the first battery receptacle 54, the manipulatable portion 40 is pushed to disengage the engagement portion 38 from the engagement groove 44, and then the battery pack BP is slid rearward away from the first battery receptacle 54. As a result, the guide rails 36 are pulled out from the guide grooves 42, completing the detachment of the battery pack BP.

The first battery receptacle 54 comprises two sets of guide grooves 42, two engagement grooves 44, and two sets of connection terminals 46. Thus, the first battery receptacle 54 is configured to allow two battery packs BP to be attached thereto.

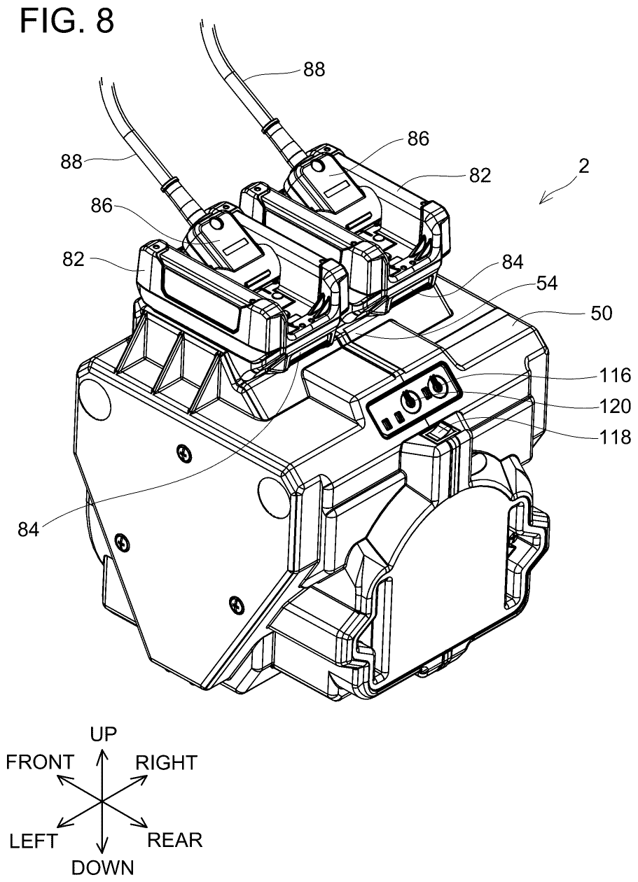

As shown in FIG. 8, the motor unit 2 further comprises adapters 82. The adapters 82 can be attached to the first battery receptacle 54 instead of the battery packs BP (see FIG. 3).

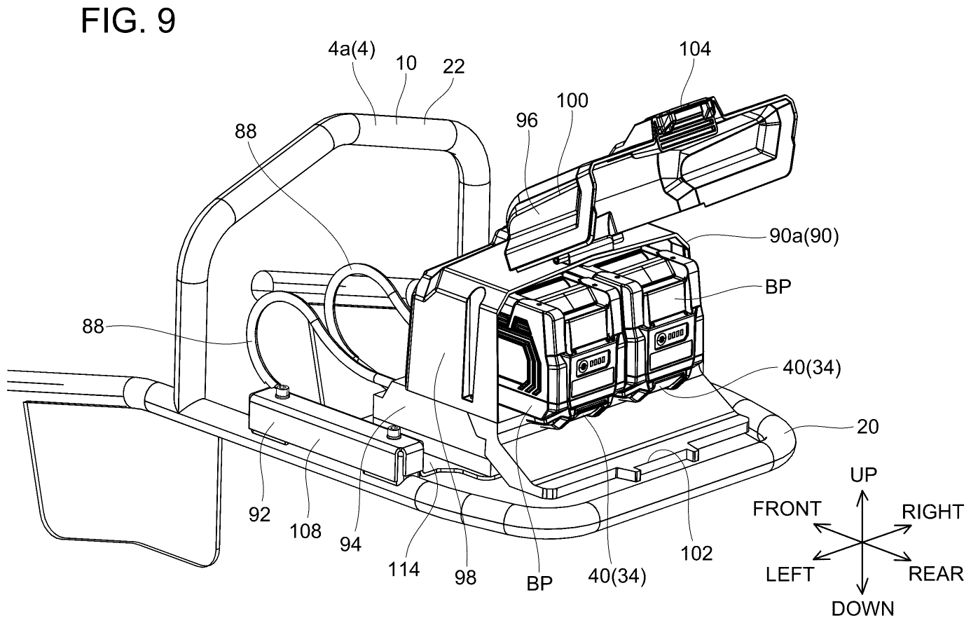

Similar to the battery packs BP, each adapter 82 comprises guide rails (not shown) configured to enter the guide grooves 42 (see FIGS. 5 and 10), a hook 84 configured to engage with the engagement groove 44 (see FIGS. 5 and 10), and adapter terminals (not shown) corresponding to the connection terminals 46 (see FIGS. 5 and 10). Thus, the adapters 82 are configured to be detachably attached to the first battery receptacle 54, similar to the battery packs BP. The adapters 82 are different from the battery packs BP in that they do not comprise secondary battery cells. Each adapter 82 is connected to one end of a cable 88 via a joint 86. Each joint 86 is rotatable about a rotation axis extending in the right-left direction relative to the corresponding adapter 82. Each cable 88 is electrically connected to the connection terminals 46 of the first battery receptacle 54 via the adapter terminals. The other ends of the cables 88 are connected to second battery receptacle 90a shown in FIG. 9. The length of the cables 88 is, for example, in a range of 100 mm to 2000 mm or may be in a range of 400 mm to 500 mm. In this embodiment, the length of the cables 88 is 450 mm.

As shown in FIG. 9, the second battery receptacle 90a comprises a base 92 mounted on the handle 10 of the rammer 4a, a body 94 to which the battery packs BP are attached, and a cover 96 configured to cover the battery packs BP attached to the body 94. The cover 96 comprises a front cover portion 98 for covering front portions of the battery packs BP attached to the body 94 and a rear cover portion 100 for covering rear portions of the battery packs BP attached to the body 94. The front cover portion 98 is fixed to the body 94. The rear cover portion 100 is pivotable on a pivot axis extending in the right-left direction relative to the front cover portion 98. A latch 104 is disposed on the outer surface of the rear cover portion 100 and is configured to engage with a latch receiver 102 formed in the body 94. As shown in FIG. 1, when the latch 104 is in engagement with the latch receiver 102, the battery packs BP attached to the body 94 are entirely covered by the front cover portion 98 and the rear cover portion 100. The state of the cover 96 shown in FIG. 1 may be referred to as a closed state. The cover 96 in the closed state can provide protection for the battery packs BP against external water and dust. In contrast, as shown in FIG. 9, after the latch 104 has been disengaged from the latch receiver 102 and the rear cover portion 100 has been moved upward, the rear portions of the battery packs BP are exposed to the exterior. The state of the cover 96 shown in FIG. 9 may be referred to as an open state. The cover 96 in the open state allows the battery packs BP to be attached to and detached from the body 94. The user brings the cover 96 into the open state when wishing to attach/detach the battery packs BP to/from the body 94 but keeps the cover 96 in the closed state otherwise.

As shown in FIG. 10, the base 92 comprises a left fitting portion 108 configured to fit to left projections 106 (see FIG. 2) disposed on a left portion of the first grip 20, a right fitting portion 112 configured to fit to right projections 110 (see FIG. 2) disposed on a right portion of the first grip 20, and a plate portion 114 extending between the left fitting portion 108 and the right fitting portion 112. The left fitting portion 108 is fastened to the left projections 106 with screws. The right fitting portion 112 is fastened to the right projections 110 with screws. The body 94 is fixed to the upper surface of the plate portion 114.

The body 94 comprises two sets of guide grooves 42, two engagement grooves 44, and two sets of connection terminals 46. The guide grooves 42, the engagement grooves 44, and the connection terminals 46 of the body 94 have the same functions as the functions of the same elements of the first battery receptacle 54 (see FIG. 5). Thus, the second battery receptacle 90a is configured to allow two battery packs BP to be attached thereto.

To attach the battery packs BP to the second battery receptacle 90a, each battery pack BP is slid forward toward the second battery receptacle 90a. As a result, the guide rails 36 (see FIG. 3) enter the guide grooves 42 and the engagement portion 38 (see FIG. 3) engages with the engagement groove 44, completing the attachment of the battery pack BP. When the battery pack BP is in the attached state to the second battery receptacle 90a, the connection terminals 46 are in the inside of the battery housing 30 (see FIG. 3) via the slits 32 (see FIG. 3) and engaged with corresponding battery terminals. Thus, the battery terminals and the connection terminals 46 are electrically connected to each other. To detach the battery pack BP from the second battery receptacle 90a, the manipulatable portion 40 is pushed to disengage the engagement portion 38 from the engagement groove 44, and then the battery pack BP is slid rearward away from the second battery receptacle 90a. As a result, the guide rails 36 are pulled out from the guide grooves 42, completing the detachment of the battery pack BP. When attaching the battery packs BP to or detaching the battery packs BP from the second battery receptacle 90a, the user standing behind the rammer 4a can handle the battery packs BP near the user's body. Thus, the user standing behind the rammer 4a can easily attach and detach the battery packs BP.

The connection terminals 46 of the body 94 and the connection terminals 46 (see FIG. 5) of the first battery receptacle 54 are common members.

The other ends of the cables 88 are connected to a front portion of the body 94. The cables 88 are electrically connected to the battery terminals of the battery packs BP attached to the second battery receptacle 90a via the connection terminals 46 of the second battery receptacle 90a. Thus, power in the battery packs BP is supplied to the electric motor 70 through the second battery receptacle 90a, the cables 88, the adapters 82, and the first battery receptacle 54.

In the motor unit 2 according to this embodiment, the adapters 82 can be detached from the first battery receptacle 54 and the battery packs BP can be attached to the first battery receptacle 54 instead, although this is not shown. In this case, the power in the battery packs BP attached to the first battery receptacle 54 is supplied to the electric motor 70 through the first battery receptacle 54.

As shown in FIG. 5, the motor unit 2 further comprises a main power switch 116, an actuation switch 118, and a rotation adjustment switch 120. The main power switch 116, the actuation switch 118, and the rotation adjustment switch 120 are disposed on the upper surface of the housing 50 and rearward of the first battery receptacle 54. The user can turn on or off the main power of the motor unit 2 by manipulating the main power switch 116. When the main power of the motor unit 2 is on, the user can drive or stop the electric motor 70 by manipulating the actuation switch 118. When the main power of the motor unit 2 is on, the user can adjust the rotating speed of the output shaft 52 by manipulating the rotation adjustment switch 120.

### Second Embodiment

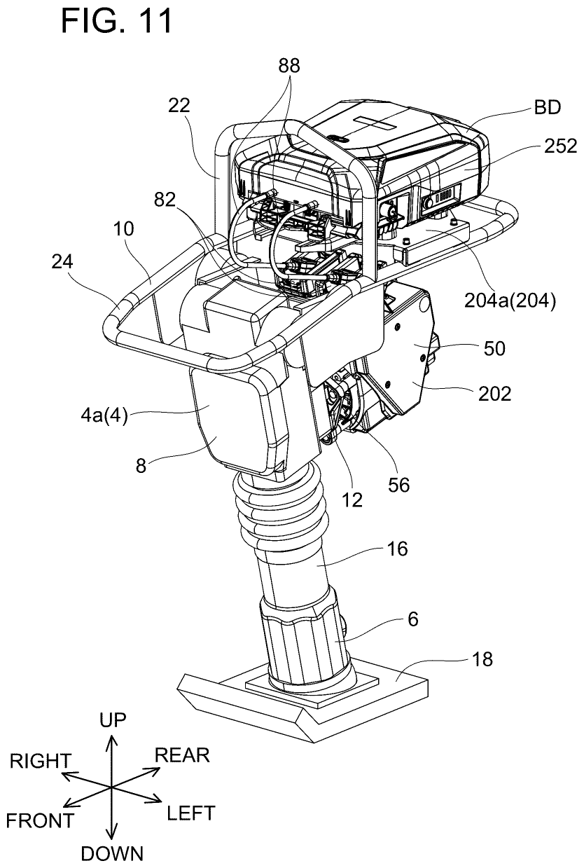

As shown in FIG. 11, in this embodiment, a working machine comprises a working unit 4 which is the same as that of the first embodiment (i.e., the rammer 4a) and a motor unit 202. The motor unit 202 is different from the motor unit 2 in the first embodiment in that the motor unit 202 comprises a second battery receptacle 204a different from the second battery receptacle 90a (see FIG. 1). Hereinafter, the working machine according to the second embodiment is described focusing on this difference (i.e., the configuration of the second battery receptacle 204a). The same elements between the first and second embodiments are labeled with the same reference signs and their descriptions are omitted.

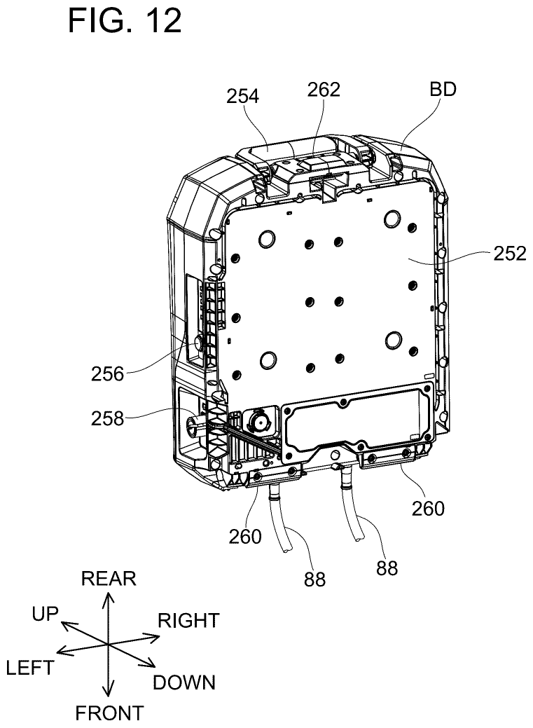

The second battery receptacle 204a is configured to allow a battery device BD to be detachably attached thereto. As shown in FIG. 12, the battery device BD has a substantially cuboid shape. The battery device BD comprises a battery housing 252, a handle 254, a main power switch 256, and a charging connector 258. A plurality of rechargeable secondary battery cells (e.g., lithium-ion battery cells) is housed in the battery housing 252. The handle 254 is disposed on a rear portion of the battery housing 252. After the battery device BD has been detached from the second battery receptacle 204a, the user can carry the battery device BD by gripping the handle 254. The main power switch 256 is disposed on the left surface of the battery housing 252. The user can turn on or off the main power of the battery device BD by manipulating the main power switch 256. The charging connector 258 is disposed on the left surface of the battery housing 252 and forward of the main power switch 256. The user can insert a charging plug (not shown) connected to an external power supply to the charging connector 258 to charge the plurality of secondary battery cells with power supplied from the external power supply. It should be noted that the directional indicator in FIG. 12 corresponds to the directional indicator in FIG. 11 (i.e., the front-rear, up-down, and right-left directions of the rammer 4a).

In this embodiment, the cables 88 are connected to the battery device BD instead of being connected to the second battery receptacle 204a. Thus, the power in the battery device BD is supplied to the electric motor 70 (see FIG. 7) through the cables 88, the adapters 82 (see FIG. 11), and the first battery receptacle 54 (see FIG. 11). The cables 88 extend from a front portion of the battery device BD.

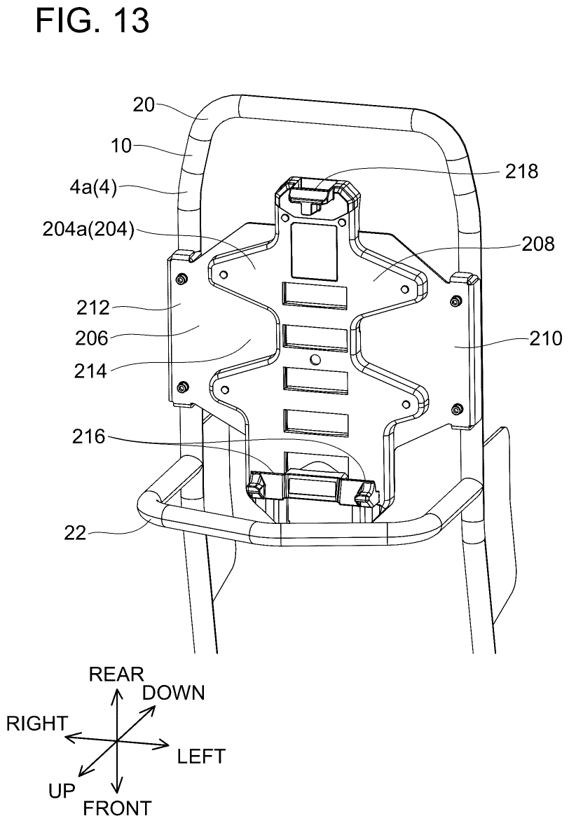

As shown in FIG. 13, the second battery receptacle 204a comprises a base 206 mounted on the handle 10 of the rammer 4a and a body 208 to which the battery device BD is attached. The base 206 comprises a left fitting portion 210 configured to fit to the left projections 106 (see FIG. 2) disposed on the left portion of the first grip 20, a right fitting portion 212 configured to fit to the right projections 110 (see FIG. 2) disposed on the right portion of the first grip 20, and a plate portion 214 extending between the left fitting portion 210 and the right fitting portion 212. The left fitting portion 210 is fastened to the left projections 106 with screws. The right fitting portion 212 is fastened to the right projections 110 with screws. The body 208 is fixed to the upper surface of the plate portion 214.

As shown in FIG. 12, the battery device BD comprises engagement claws 260 for engagement with the body 208 of the second battery receptacle 204a and a latch 262 manipulatable by the user. The engagement claws 260 are disposed on a front portion of the battery housing 252. The latch 262 is disposed on a rear portion of the battery housing 252. As shown in FIG. 13, the body 208 comprises claw receivers 216 corresponding to the engagement claws 260 of the battery device BD and a latch receiver 218 corresponding to the latch 262 of the battery device BD. The user can attach the battery device BD to the second battery receptacle 204a by engaging the engagement claws 260 with the claw receivers 216 and also engaging the latch 262 with the latch receiver 218. When the battery device BD is in the attached state to the second battery receptacle 204a, the user can disengage the latch 262 from the latch receiver 218 by manipulating the latch 262. The user can detach the battery device BD from the second battery receptacle 204a by pulling out the engagement claws 260 from the claw receivers 216 after the disengagement of the latch 262 from the latch receiver 218.

As shown in FIG. 11, the battery device BD is attached to the second battery receptacle 204a such that its longitudinal direction is along the front-rear direction of the rammer 4a. The battery device BD is attached to the second battery receptacle 204a such that the latch 262 (see FIG. 12) faces rearward. Thus, the latch 262 is positioned for the user standing behind the rammer 4a to easily manipulate the latch 262. Therefore, the user standing behind the rammer 4a can easily attach or detach the battery device BD.

The battery device BD can be detached from the second battery receptacle 204a and attached to a backpack (not shown) worn on the user's back. In this case, the user carrying the backpack on the back can attach the adapters 82 (see FIG. 11) to a different electric tool (e.g., the electric tool T shown in FIG. 4) than the motor unit 2 to supply power from the battery device BD to the electric tool.

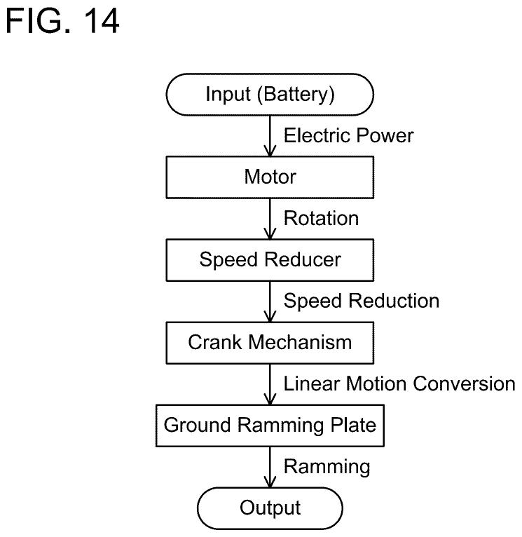

FIG. 14 schematically shows a power transmission flow in the working machines according to the first and second embodiments. The working machines according to the first and second embodiments drive the motor units 2, 202 (i.e., the electric motor 70) to rotate the output shaft 52. The working machines reduces the rotational motion of the output shaft 52 via a speed reducer and converts it to a linear motion via the crank mechanism to provide impacts by the ground ramming plate 18 (i.e., ground-ramming operation).

### Third Embodiment

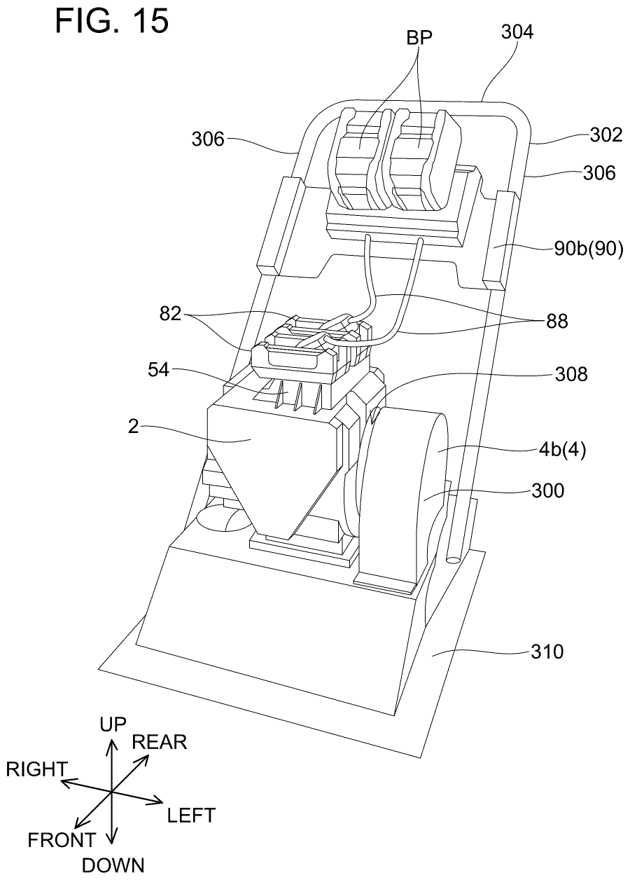

As shown in FIG. 15, a working machine according to this embodiment comprises a plate compactor 4b and a motor unit 2. This motor unit 2 is similar to that described in the first embodiment.

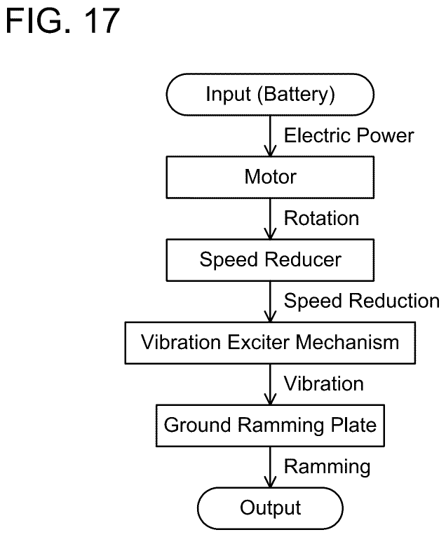

The plate compactor 4b comprises a body 300 and a handle 302 mounted on the body 300. The handle 302 comprises a grip 304 gripped by the user during the use of the working machine and two support pillars 306 extending between the grip 304 and the body 300. The body 300 comprises a mounting base 308 to which the motor unit 2 is attached and a ground ramming plate 310 driven by the motor unit 2. The mounting base 308 is the same as the mounting base 12 described in the first embodiment. Thus, the front mounting portion 56 (see FIG. 6) of the motor unit 2 is attached to the mounting base 308. When the electric motor 70 (see FIG. 7) of the motor unit 2 operates, a vibration exciter mechanism (e.g., an eccentric weight) mounted on the ground ramming plate 310 operates, thereby vibrating the ground ramming plate 310 in the up-down direction. The plate compactor 4b vibrates the ground ramming plate 310 in the up-down direction with the ground ramming plate 310 faced toward the ground to press the ground ramming plate 310 against the ground repeatedly. The plate compactor 4b compacts the ground in this way. FIG. 17 schematically shows a power transmission flow in the working machine according to this embodiment as described above.

In this embodiment, a front-rear direction, up-down direction, and right-left direction of the plate compactor 4b are defined based on a working orientation of the plate compactor 4b. Specifically, the vertical direction when the ground ramming plate 310 is placed on a horizontal surface is defined as the up-down direction of the plate compactor 4b, a direction that is perpendicular to the up-down direction and from the grip 304 toward the body 300 is defined as the front direction, the opposite direction to the front direction is defined as the rear direction, and a direction perpendicular to the front-rear direction and the up-down direction is defined as the right-left direction.

In this embodiment, the motor unit 2 comprises a second battery receptacle 90b corresponding to the plate compactor 4b instead of the second battery receptacle 90a (see FIG. 5) described in the first embodiment. The second battery receptacle 90b is mounted on the two support pillars 306 of the plate compactor 4b to bridge them. The two support pillars 306 extend upward and rearward from the body 300 and are connected to the grip 304. Similar to the second battery receptacle 90a in the first embodiment, the second battery receptacle 90b is configured to allow two battery packs BP to be attached thereto. The battery packs BP are attached to the second battery receptacle 90b by being slid forward and downward toward the second battery receptacle 90b. The battery packs BP are detached from the second battery receptacle 90b by being slid rearward and upward away from the second battery receptacle 90b. Thus, when attaching the battery pack BP to or detaching the battery pack BP from the second battery receptacle 90b, the user standing behind the plate compactor 4b can handle the battery pack BP near the user's body. Therefore, the user standing behind the plate compactor 4b can easily attach and detach the battery pack BP.

Each adapter 82 is attached to the first battery receptacle 54 by being slid leftward toward the first battery receptacle 54. The adapter 82 is detached from the first battery receptacle 54 by being slid rightward away from the first battery receptacle 54. In this embodiment, the first battery receptacle 54 is disposed at a position easily accessible by the user (on the upper surface of the plate compactor 4b). Thus, the user can easily attach and detach the adapter 82.

### Fourth Embodiment

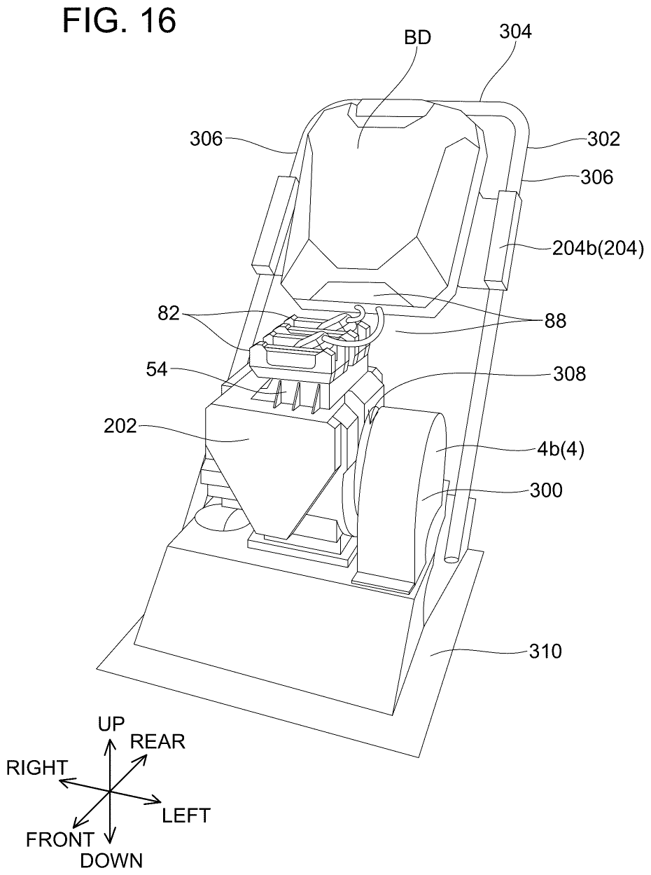

As shown in FIG. 16, a working machine according to this embodiment comprises a plate compactor 4b and a motor unit 202. This plate compactor 4b is similar to that described in the third embodiment, and this motor unit 202 is similar to that described in the second embodiment.

In this embodiment, the motor unit 202 comprises a second battery receptacle 204b corresponding to the plate compactor 4b instead of the second battery receptacle 204a (see FIG. 13) described in the second embodiment. The second battery receptacle 204b are mounted on the two support pillars 306 of the plate compactor 4b to bridge them. Similar to the second battery receptacle 204a in the second embodiment, the second battery receptacle 204b is configured to allow the battery device BD to be detachably attached thereto.

The battery device BD is attached to the second battery receptacle 204b such that the latch 262 (see FIG. 12) faces rearward and upward. Thus, the latch 262 is positioned for the user standing behind the plate compactor 4b to easily manipulate the latch 262. Therefore, the user standing behind the plate compactor 4b can easily attach and detach the battery device BD.

The adapters 82 are attached to the first battery receptacle 54 by being slid leftward toward the first battery receptacle 54. The adapters 82 are detached from the first battery receptacle 54 by being slid rightward away from the first battery receptacle 54. In this embodiment, the first battery receptacle 54 is disposed at a position easily accessible by the user (on the upper surface of the plate compactor 4b). Thus, the user can easily attach and detach the adapters 82.

### Fifth Embodiment

As shown in FIG. 18, a working machine according to this embodiment comprises a trowel 4c and a motor unit 2. This motor unit 2 is similar to that described in the first embodiment.

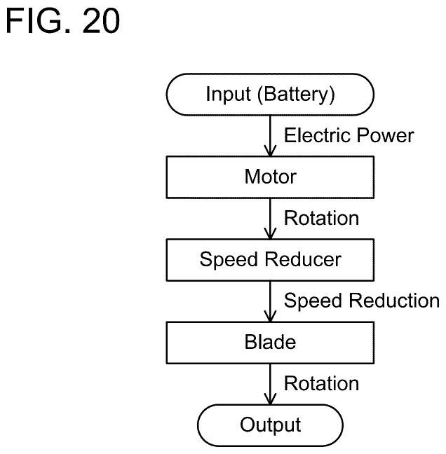

The trowel 4c comprises a body 320 and a handle 322 attached to the body 320. The handle 322 comprises a grip 324 gripped during the use of the working machine and a support pillar 326 extending between the grip 324 and the body 320. The body 320 comprises a mounting base 328 to which the motor unit 2 is attached and a plurality of blades 330 driven by the motor unit 2. A plurality of through holes positioned aligned with the plurality of screw holes 68 (see FIG. 6) is defined in the mounting base 328. By inserting screws into the plurality of through holes and screwing the screws into the plurality of screw holes 68, the motor unit 2 is attached to the trowel 4c with the lower contact surface 66 (see FIG. 6) being in contact with the upper surface of the mounting base 328. When the electric motor 70 (see FIG. 7) of the motor unit 2 operates, the plurality of blades 330 rotates. The trowel 4c has rotary surfaces of the plurality of blades 330 contact the concrete surface to level the concrete surface. FIG. 20 schematically shows a power transmission flow in the working machine according to this embodiment as described above.

In this embodiment, a front-rear direction, up-down direction, and right-left direction of the trowel 4c are defined based on a working orientation of the trowel 4c. Specifically, a direction that is along the rotation axis of the plurality of blades 330 and is from the motor unit 2 toward the plurality of blades 330 is defined as the down direction, the opposite direction to the down direction is defined as the up direction, a direction that is perpendicular to the up-down direction and is from the grip 324 toward the body 320 is defined as the front direction, the opposite direction to the front direction is defined as the rear direction, and a direction perpendicular to the front-rear direction and the up-down direction is defined as the right-left direction.

In this embodiment, the motor unit 2 comprises a second battery receptacle 90c corresponding to the trowel 4c instead of the second battery receptacle 90a (see FIG. 5) described in the first embodiment. The second battery receptacle 90c is mounted on the support pillar 326 of the trowel 4c. The support pillar 326 extends rearward and upward from the body 320 and is connected to the grip 324. Similar to the second battery receptacle 90a in the first embodiment, the second battery receptacle 90c is configured to allow two battery packs BP to be detachably attached thereto. Each battery pack BP is attached to the second battery receptacle 90c by being slid forward and downward toward the second battery receptacle 90c. The battery pack BP is detached from the second battery receptacle 90c by being slid rearward and upward away from the second battery receptacle 90c. Thus, when attaching the battery pack BP to or detaching the battery pack BP from the second battery receptacle 90c, the user standing behind the trowel 4c can handle the battery pack BP near the user's body. Therefore, the user standing behind the trowel 4c can easily attach and detach the battery pack BP. In this embodiment, the two cables 88 extending from the second battery receptacle 90c are each bounded with the support pillar 326 of the trowel 4c at their intermediate portions 88m. This prevents the cables 88 from getting in the way during use.

The adapters 82 are attached to the first battery receptacle 54 by being slid leftward toward the first battery receptacle 54. The adapters 82 are detached from the first battery receptacle 54 by being slid rightward away from the first battery receptacle 54. In this embodiment, the first battery receptacle 54 is disposed at a position easily accessible by the user (on the upper surface of the trowel 4c). Thus, the user can easily attach and detach the adapters 82.

### Sixth Embodiment

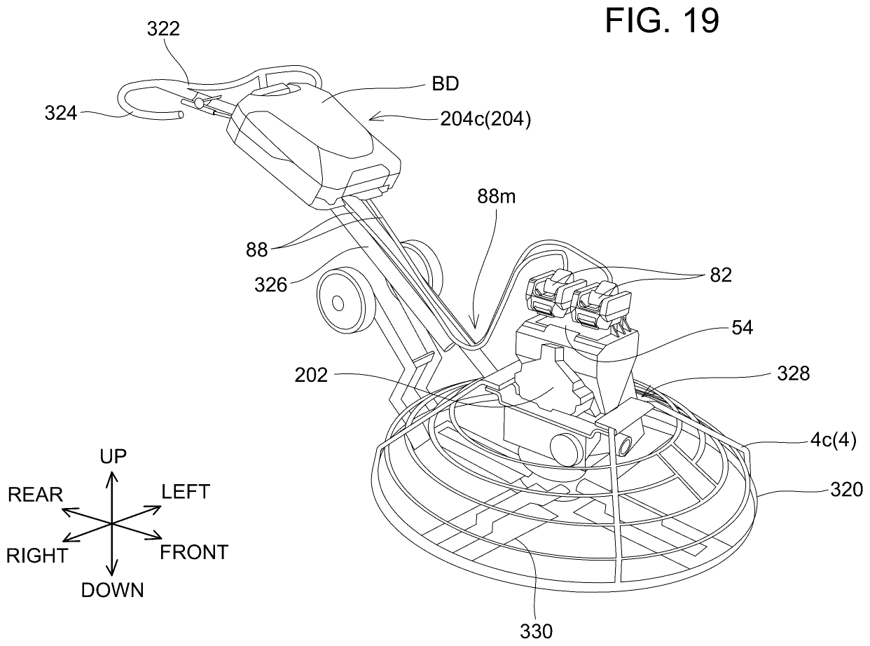

As shown in FIG. 19, a working machine according to this embodiment comprises a trowel 4c and a motor unit 202. This trowel 4c is similar to that described in the fifth embodiment and the motor unit 202 is similar to that described in the second embodiment.

In this embodiment, the motor unit 202 comprises a second battery receptacle 204c corresponding to the trowel 4c instead of the second battery receptacle 204a (see FIG. 13) described n connection with the second embodiment. The second battery receptacle 204c is mounted on the support pillar 326 of the trowel 4c. Similar to the second battery receptacle 204a in the second embodiment, the second battery receptacle 204c is configured to allow the battery device BD to be detachably attached thereto.

The battery device BD is attached to the second battery receptacle 204c such that the latch 262 (see FIG. 12) faces rearward and upward. Thus, the latch 262 is positioned for the user standing behind the trowel 4c to easily manipulate the latch 262. Therefore, the user standing behind the trowel 4c can easily attach and detach the battery device BD.

The adapters 82 are attached to the first battery receptacle 54 by being slid leftward toward the first battery receptacle 54. The adapters 82 are detached from the first battery receptacle 54 by being slid rightward away from the first battery receptacle 54. In this embodiment, the first battery receptacle 54 is disposed at a position easily accessible by the user (on the upper surface of the trowel 4c). Thus, the user can easily attach and detach the adapters 82.

### Seventh Embodiment

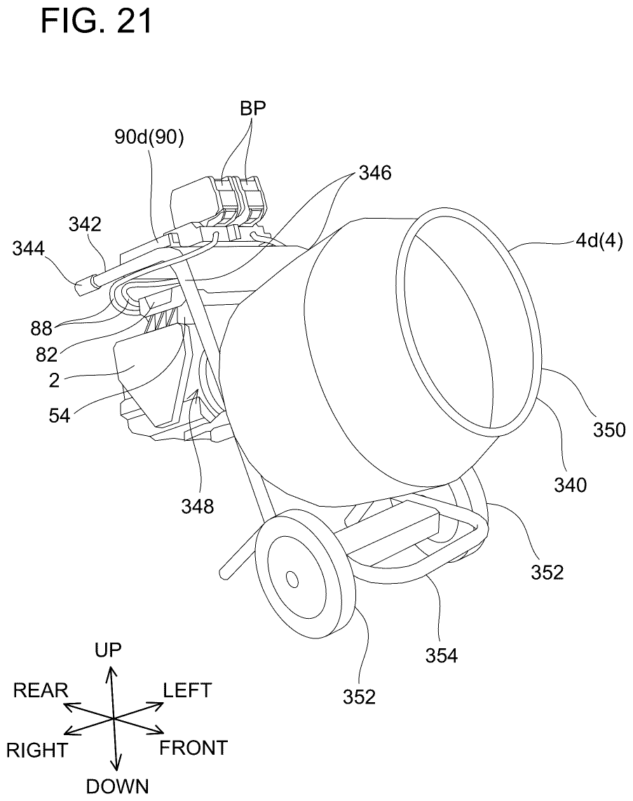

As shown in FIG. 21, a working machine according to this embodiment comprises a concrete mixer 4d and a motor unit 2. This motor unit 2 is similar to that described in the first embodiment.

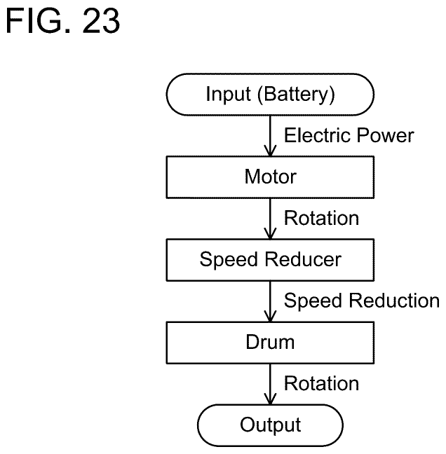

The concrete mixer 4d comprises a body 340 and a handle 342 attached to the body 340. The handle 342 comprises a grip 344 gripped by the user during use and two support pillars 346 extending between the grip 344 and the body 340. The body 340 comprises a mounting base 348 to which the motor unit 2 is attached, a rotary drum 350 driven by the motor unit 2, and a carriage 354 including wheels 352. The mounting base 348 is similar to the mounting base 12 described in the first embodiment. Thus, the front mounting portion 56 (see FIG. 6) of the motor unit 2 is attached to the mounting base 348. When the electric motor 70 (see FIG. 7) of the motor unit 2 operates, the rotary drum 350 rotates. The rotary drum 350 houses concrete. The concrete mixer 4d rotates the rotary drum 350 to mix the concrete. FIG. 23 schematically shows a power transmission flow in the working machine according to this embodiment as described above. The user can move the concrete mixer 4d by gripping the grip 344 and pushing the concrete mixer 4d with the carriage 354 (i.e., the wheels 352) placed on the ground.

In this embodiment, a front-rear direction, up-down direction, right-left direction of the concrete mixer 4d are defined based on a working orientation of the concrete mixer 4d. Specifically, vertically up-down direction when the carriage 354 (i.e., the wheels 352) is placed on a horizontal surface is defined as the up-down direction of the concrete mixer 4d, a direction that is perpendicular to the up-down direction and is from the grip 344 toward the body 340 is defined as the front direction, the opposite direction to the front direction is defined as the rear direction, and a direction perpendicular to the front-rear direction and the up-down direction is defined as the right-left direction.

In this embodiment, the motor unit 2 comprises a second battery receptacle 90d corresponding to the concrete mixer 4d instead of the second battery receptacle 90a (see FIG. 5) described in the first embodiment. The second battery receptacle 90d is mounted on the two support pillars 346 of the concrete mixer 4d to bridge them. The two support pillars 346 extend rearward and upward from the body 340, bend and extend rearward, and then connect to the grip 344. The second battery receptacle 90d is mounted on the rearwardly extending portions of the two support pillars 346 (i.e., portions closer to the grip 344 than the bends are). Similar to the second battery receptacle 90a in the first embodiment, the second battery receptacle 90d is configured to allow two battery packs BP to be detachably attached thereto. Each battery pack BP is attached to the second battery receptacle 90d by being slid forward toward the second battery receptacle 90d. The battery pack BP is detached from the second battery receptacle 90d by being slid rearward away from the second battery receptacle 90d. Thus, when attaching the battery pack BP to or detaching the battery pack BP from the second battery receptacle 90d, the user standing behind the concrete mixer 4d can handle the battery pack BP near the user's body. Therefore, the user standing behind the concrete mixer 4d can easily attach and detach the battery pack BP.

The adapters 82 are attached to the first battery receptacle 54 by being slid forward toward the first battery receptacle 54. The adapters 82 are detached from the first battery receptacle 54 by being slid rearward away from the first battery receptacle 54.

### Eighth Embodiment

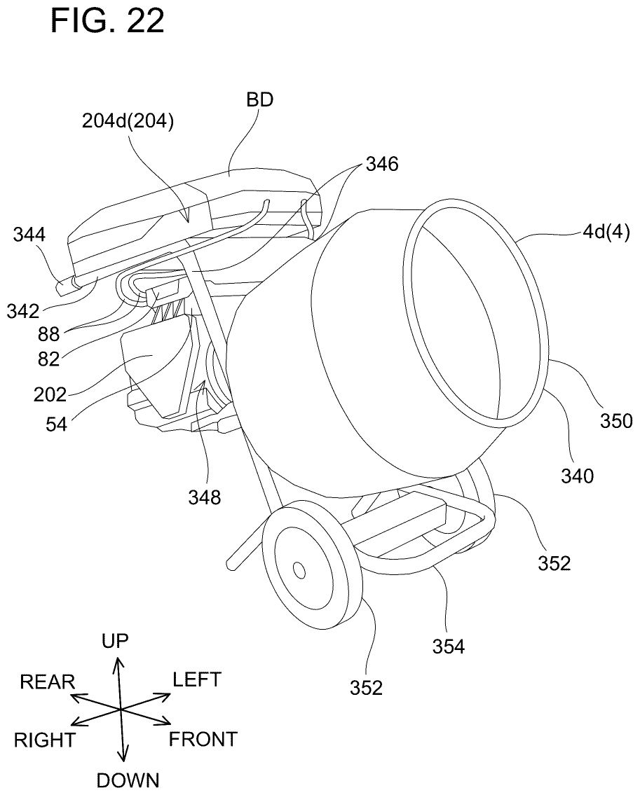

As shown in FIG. 22, a working machine according to this embodiment comprises a concrete mixer 4d and a motor unit 202. This concrete mixer 4d is similar to that described in the seventh embodiment and this motor unit 202 is similar to that described in the second embodiment.

In this embodiment, the motor unit 202 comprises a second battery receptacle 204d corresponding to the concrete mixer 4d instead of the second battery receptacle 204a (see FIG. 13) described in the second embodiment. The second battery receptacle 204d is mounted on the rearwardly extending portions of the two support pillars 346 (i.e., portions closer to the grip 344 than the bends are) to bridge the two support pillars 346. Similar to the second battery receptacle 204a in the second embodiment, the second battery receptacle 204d is configured to allow the battery device BD to be detachably attached thereto.

The battery device BD is attached to the second battery receptacle 204d such that the latch 262 (see FIG. 12) faces rearward. Thus, the latch 262 is positioned for the user standing behind the concrete mixer 4d to easily manipulate the latch 262. Therefore, the user standing behind the concrete mixer 4d can easily attach and detach the battery device BD.

The adapters 82 are attached to the first battery receptacle 54 by being slid forward toward the first battery receptacle 54. The adapters 82 are detached from the first battery receptacle 54 by being slid rearward away from the first battery receptacle 54.

### Ninth Embodiment

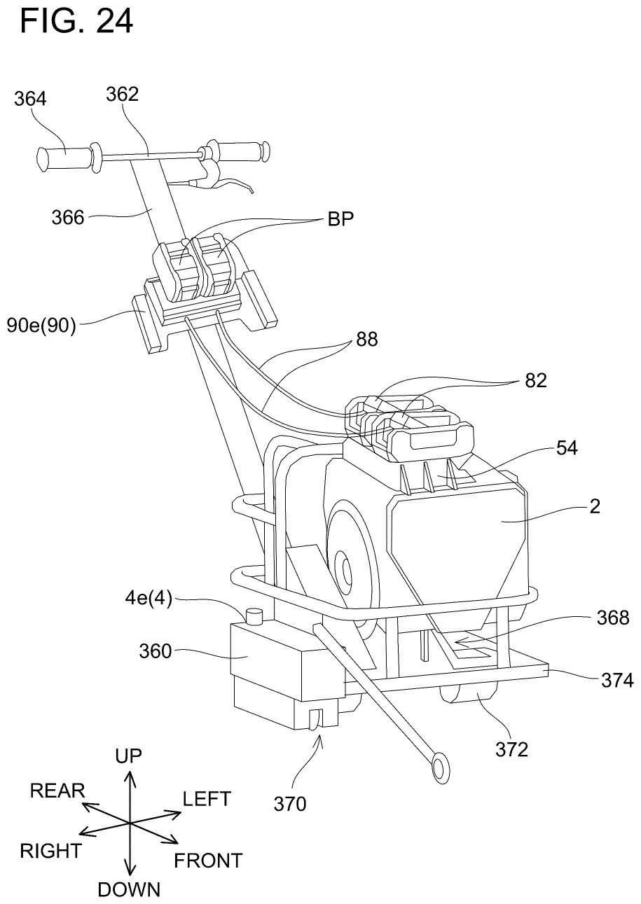

As shown in FIG. 24, a working machine according to this embodiment comprises a concrete saw 4e and a motor unit 2. The motor unit 2 is similar to that described in the first embodiment.

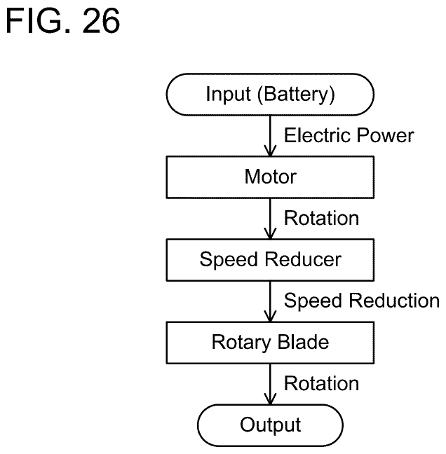

The concrete saw 4e comprises a body 360 and a handle 362 attached to the body 360. The handle 362 comprises a grip 364 gripped by the user during use and a support pillar 366 extending between the grip 364 and the body 360. The body 360 comprises a mounting base 368 to which the motor unit 2 is attached, a rotary blade 370 driven by the motor unit 2, and a carriage 374 including wheels 372. The mounting base 368 is similar to the mounting base 328 (see FIG. 18) described in the fifth embodiment. Thus, the lower mounting portion 64 (see FIG. 6) of the motor unit 2 is attached to the mounting base 368. When the electric motor 70 (see FIG. 7) of the motor unit 2 operates, the rotary blade 370 rotates. The concrete saw 4e makes cuts (referred to as masonry joints) in concrete paved on the ground using the rotary blade 370. FIG. 26 schematically shows a power transmission flow in the working machine according to this embodiment described above. The user can move the concrete saw 4e by gripping the grip 364 and pushing the concrete saw 4e with the carriage 374 (i.e., the wheels 372) placed on the ground.

In this embodiment, a front-rear direction, up-down direction, and right-left direction of the concrete saw 4e are defined based on a working orientation of the concrete saw 4e. Specifically, a vertically up-down direction when the carriage 374 (i.e., the wheels 372) is on a horizontal surface is defined as the up-down direction of the concrete saw 4e, a direction that is perpendicular to the up-down direction and is from the grip 364 toward the body 360 is defined as the front direction, the opposite direction to the front direction is defined as the rear direction, and a direction perpendicular to the front-rear direction and the up-down direction is defined as the right-left direction.

In this embodiment, the motor unit 2 comprises a second battery receptacle 90e corresponding to the concrete saw 4e instead of the second battery receptacle 90a (see FIG. 5) described in the first embodiment. The second battery receptacle 90e is mounted on the support pillar 366 of the concrete saw 4e. The support pillar 366 extends rearward and upward from the body 360 and connects to the grip 364. Similar to the second battery receptacle 90a in the first embodiment, the second battery receptacle 90e is configured to allow two battery packs BP to be detachably attached thereto. Each battery pack BP is attached to the second battery receptacle 90e by being slid forward and downward toward the second battery receptacle 90e. The battery pack BP is detached from the second battery receptacle 90e by being slid rearward and upward away from the second battery receptacle 90e. Thus, when attaching the battery pack BP to or detaching the battery pack BP from the second battery receptacle 90e, the user standing behind the concrete saw 4e can handle the battery pack BP near the user's body. Therefore, the user standing behind the concrete saw 4e can easily attach and detach the battery pack BP.

The adapters 82 are attached to the first battery receptacle 54 by being slid rightward toward the first battery receptacle 54. The adapters 82 are detached from the first battery receptacle 54 by being slid leftward away from the first battery receptacle 54. In this embodiment, the first battery receptacle 54 is disposed at a position easily accessible by the user (on the upper surface of the concrete saw 4e). Thus, the user can easily attach and detach the adapters 82.

### Tenth Embodiment

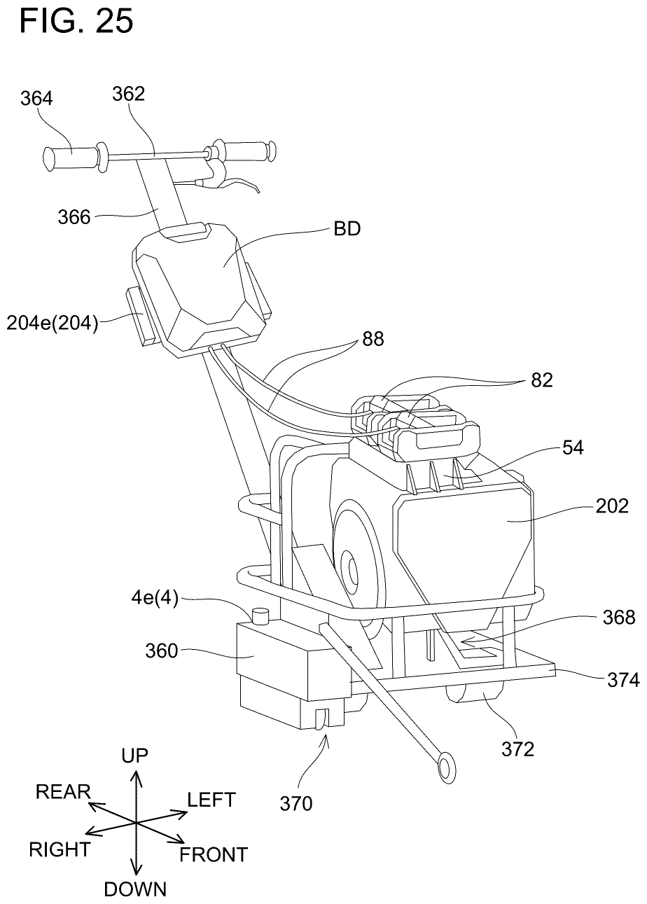

As shown in FIG. 25, a working machine according to this embodiment comprises a concrete saw 4e and a motor unit 202. This concrete saw 4e is similar to that described in the ninth embodiment and this motor unit 202 is similar to that described in the second embodiment.

In this embodiment, the motor unit 202 comprises a second battery receptacle 204e corresponding to the concrete saw 4e instead of the second battery receptacle 204a (see FIG. 13) described in the second embodiment. The second battery receptacle 204e is mounted on the support pillar 366 of the concrete saw 4e. Similar to the second battery receptacle 204a in the second embodiment, the second battery receptacle 204e is configured to allow the battery device BD to be detachably attached thereto.

The battery device BD is attached to the second battery receptacle 204e such that the latch 262 (see FIG. 12) faces rearward and upward. Thus, the latch 262 is positioned for the user standing behind the concrete saw 4e to easily manipulate the latch 262. Therefore, the user standing behind the concrete saw 4e can easily attach and detach the battery device BD.

The adapters 82 are attached to the first battery receptacle 54 by being slid rightward toward the first battery receptacle 54. The adapters 82 are detached from the first battery receptacle 54 by being slid leftward away from the first battery receptacle 54. In this embodiment, the first battery receptacle 54 is disposed at a position easily accessible by the user (on the upper surface of the concrete saw 4e). Thus, the user can easily attach and detach the adapters 82.

### Eleventh Embodiment

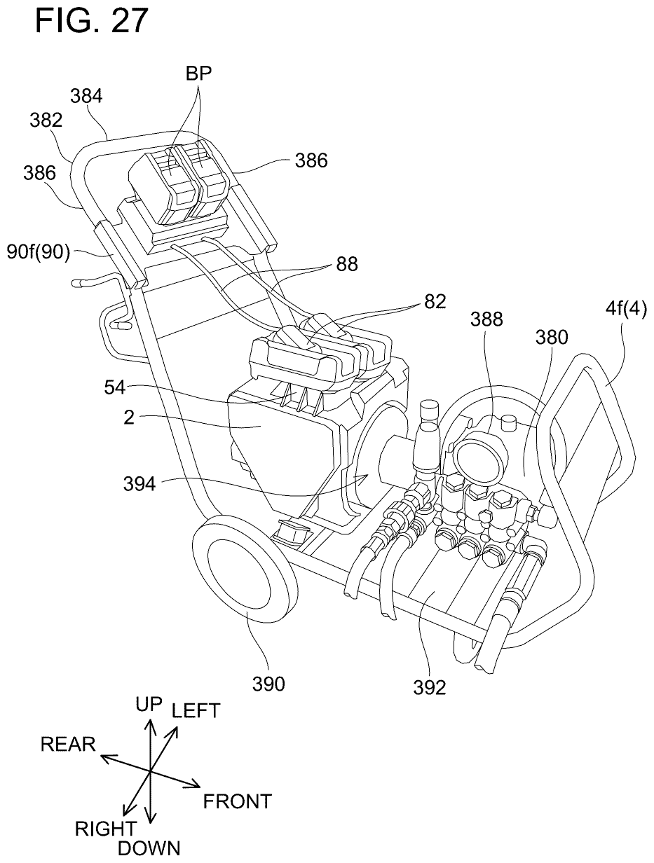

As shown in FIG. 27, a working machine according to this embodiment comprises a pressure washer 4f and a motor unit 2. This motor unit 2 is similar to that described in the first embodiment.

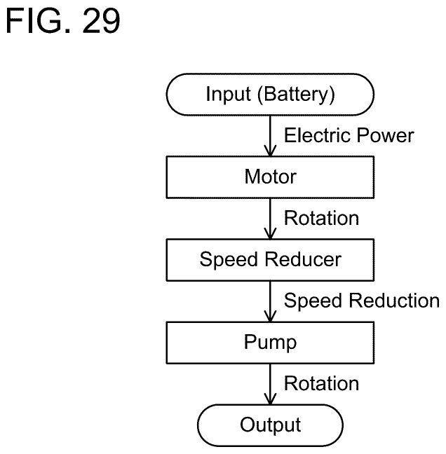

The pressure washer 4f comprises a body 380 and a handle 382 attached to the body 380. The handle 382 comprises a grip 384 gripped by the user during use and two support pillars 386 extending between the grip 384 and the body 380. The body 380 comprises a pump 388 driven by the motor unit 2 and a carriage 392 including wheels 390. The pump 388 comprises a mounting base 394 to which the motor unit 2 is attached. The mounting base 394 is similar to the mounting base 12 described in the first embodiment. Thus, the front mounting portion 56 (see FIG. 6) of the motor unit 2 is attached to the mounting base 394. Further, a water supply hose (not shown) connecting to a water source (e.g., water supply) and a water discharge hose (not shown) including an injection nozzle at an end are connected to the pump 388. When the electric motor 70 (see FIG. 7) of the motor unit 2 operates, the pump 388 is driven to pump water supplied through the water supply hose to the water discharge hose. As a result, the water is ejected from the injection nozzle. The pressure washer 4f washes a target (e.g., a car) with the water ejected from the injection nozzle. FIG. 29 schematically shows a power transmission flow in the working machine according to this embodiment described above. The user can move the pressure washer 4f by gripping the grip 384 and pushing the pressure washer 4f with the carriage 392 (i.e., the wheels 390) placed on the ground.

In this embodiment, a front-rear direction, up-down direction, and right-left direction of the pressure washer 4f are defined based on a working orientation of the pressure washer 4f. Specifically, a vertically up-down direction when the carriage 392 (i.e., the wheels 390) is on a horizontal surface is defined as the up-down direction of the pressure washer 4f, a direction that is perpendicular to the up-down direction and is from the grip 384 toward the body 380 is defined as the front direction, the opposite direction to the front direction is defined as the rear direction, and a direction perpendicular to the front-rear direction and the up-down direction is defined as the right-left direction.

In this embodiment, the motor unit 2 comprises a second battery receptacle 90f corresponding to the pressure washer 4f instead of the second battery receptacle 90a (see FIG. 5) described in the first embodiment. The second battery receptacle 90f is mounted on the two support pillars 386 of the pressure washer 4f to bridge them. The two support pillars 386 extend rearward and upward from the body 380 and connect to the grip 384. Similar to the second battery receptacle 90a in the first embodiment, the second battery receptacle 90f is configured to allow two battery packs BP to be detachably attached thereto. Each battery pack BP is attached to the second battery receptacle 90f by being slid forward and downward toward the second battery receptacle 90f. The battery pack BP is detached from the second battery receptacle 90f by being slid rearward and upward away from the second battery receptacle 90f. Thus, when attaching the battery pack BP to or detaching the battery pack BP from the second battery receptacle 90f, the user standing behind the pressure washer 4f can handle the battery pack BP near the user's body. Therefore, the user standing behind the pressure washer 4f can easily attach and detach the battery pack BP.

The adapters 82 are attached to the first battery receptacle 54 by being slid forward toward the first battery receptacle 54. The adapters 82 are detached from the first battery receptacle 54 by being slid rearward away from the first battery receptacle 54. In this embodiment, the first battery receptacle 54 is disposed at a position easily accessible by the user (on the upper surface of the pressure washer 4f). Thus, the user can easily attach and detach the adapters 82.

### Twelfth Embodiment

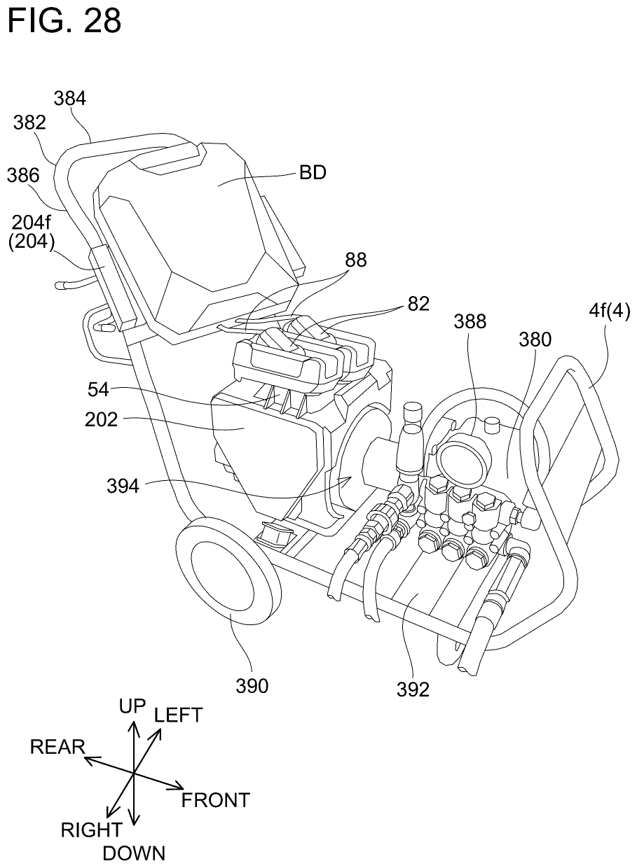

As shown in FIG. 28, a working machine according to this embodiment comprises a pressure washer 4f and a motor unit 202. This pressure washer 4f is similar to that described in the eleventh embodiment and this motor unit 202 is similar to that described in the second embodiment.

In this embodiment, the motor unit 202 comprises a second battery receptacle 204f corresponding the pressure washer 4f instead of the second battery receptacle 204a (see FIG. 13) described in the second embodiment. The second battery receptacle 204f is mounted on the two support pillars 386 to bridge them. Similar to the second battery receptacle 204a in the second embodiment, the second battery receptacle 204f is configured to allow the battery device BD to be detachably attached thereto.

The battery device BD is attached to the second battery receptacle 204f such that the latch 262 (see FIG. 12) faces rearward and upward. Thus, the latch 262 is positioned for the user standing behind the pressure washer 4f to easily manipulate the latch 262. Therefore, the user standing behind the pressure washer 4f can easily attach and detach the battery device BD.

The adapters 82 are attached to the first battery receptacle 54 by being slid forward toward the first battery receptacle 54. The adapters 82 are detached from the first battery receptacle 54 by being slid rearward away from the first battery receptacle 54. In this embodiment, the first battery receptacle 54 is disposed at a position easily accessible by the user (on the upper surface of the pressure washer 4f). Thus, the user can easily attach and detach the adapters 82.

### Thirteenth Embodiment

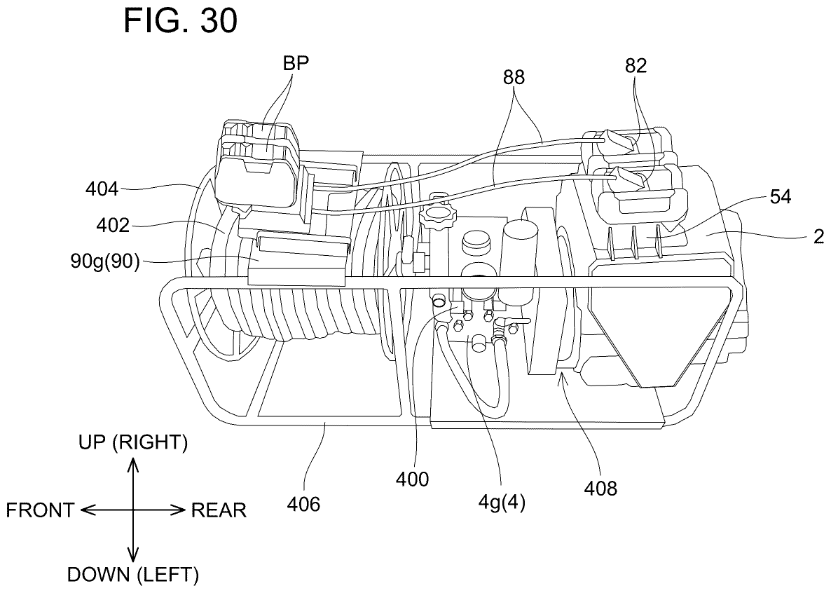

As shown in FIG. 30, a working machine according to this embodiment comprises a sprayer 4g and a motor unit 2. This motor unit 2 is similar to that described in the first embodiment.

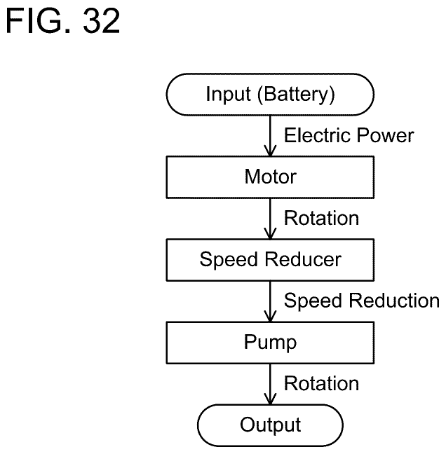

The sprayer 4g comprises a pump 400, a reel 404 on which a hose 402 is wounded, and a frame 406 supporting the pump 400 and the reel 404. The pump 400 comprises a mounting base 408 to which the motor unit 2 is attached. The mounting base 408 is similar to the mounting base 12 described in the first embodiment. Thus, the front mounting portion 56 (see FIG. 6) of the motor unit 2 is attached to the mounting base 408. A tank storing a liquid therein (not shown) and the hose 402 are connected to the pump 400. An injection nozzle (not shown) is disposed at an end of the hose 402. When the electric motor 70 (see FIG. 7) of the motor unit 2 operates, the pump 400 is driven to pump the liquid in the tank to the hose 402. As a result, the liquid is ejected from the injection nozzle. The sprayer 4g sprays the liquid (e.g., agrichemicals) in the tank. FIG. 32 schematically shows a power transmission flow in the working machine according to this embodiment described above.

In this embodiment, a front-rear direction, up-down direction, and right-left direction of the sprayer 4g are defined based on a working orientation of the sprayer 4g. Specifically, a vertically up-down direction when the frame 406 is on a horizontal surface is defined as the up-down direction of the sprayer 4g, a direction that is perpendicular to the up-down direction and is from the pump 400 toward the reel 404 is defined as the front direction, the opposite direction to the front direction is defined as the rear direction, and a direction perpendicular to the front-rear direction and the up-down direction is defined as the right-left direction.

In this embodiment, the motor unit 2 comprises a second battery receptacle 90g corresponding to the sprayer 4g instead of the second battery receptacle 90a (see FIG. 5) described in the first embodiment. The second battery receptacle 90g is mounted on upper ends of the frame 406. Similar to the second battery receptacle 90a in the first embodiment, the second battery receptacle 90g is configured to allow two battery packs BP to be detachably attached thereto. Each battery pack BP is attached to the second battery receptacle 90g be being slid rearward toward the second battery receptacle 90g. The battery pack BP is detached from the second battery receptacle 90g by being slid forward away from the second battery receptacle 90g. In this embodiment, the second battery receptacle 90g is disposed at a position easily accessible by the user (on the upper surface of the sprayer 4g). Thus, the user can easily attach and detach the battery pack BP.

The adapters 82 are attached to the first battery receptacle 54 by being slid forward toward the first battery receptacle 54. The adapters 82 are detached from the first battery receptacle 54 by being slid rearward away from the first battery receptacle 54. In this embodiment, the first battery receptacle 54 is disposed at a position easily accessible by the user (on the upper surface of the sprayer 4g). Thus, the user can easily attach and detach the adapters 82.

### Fourteenth Embodiment

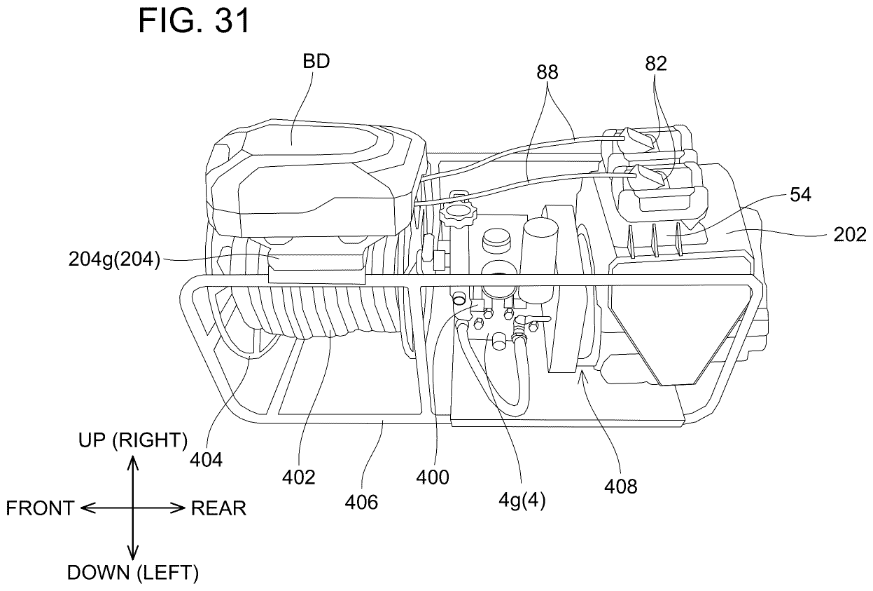

As shown in FIG. 31, a working machine according to this embodiment comprises a sprayer 4g and a motor unit 202. This sprayer 4g is similar to that described in the thirteenth embodiment and this motor unit 202 is similar to that described in the second embodiment.

In this embodiment, the motor unit 202 comprises a second battery receptacle 204g corresponding to the sprayer 4g instead of the second battery receptacle 204a (see FIG. 13) described in the second embodiment. The second battery receptacle 204g is mounted on the upper ends of the frame 406. Similar to the second battery receptacle 204a in the second embodiment, the second battery receptacle 204g is configured to allow the battery device BD to be detachably attached thereto. In this embodiment, the second battery receptacle 204g is disposed at a position easily accessible by the user (on the upper surface of the sprayer 4g). Thus, the user can easily attach and detach the battery device BD.

The adapters 82 are attached to the first battery receptacle 54 by being slid forward toward the first battery receptacle 54. The adapters 82 are detached from the first battery receptacle 54 by being slid rearward away from the first battery receptacle 54. In this embodiment, the first battery receptacle 54 is disposed at a position easily accessible by the user (on the upper surface of the sprayer 4g). Thus, the user can easily attach and detach the adapters 82.

### Fifteenth Embodiment

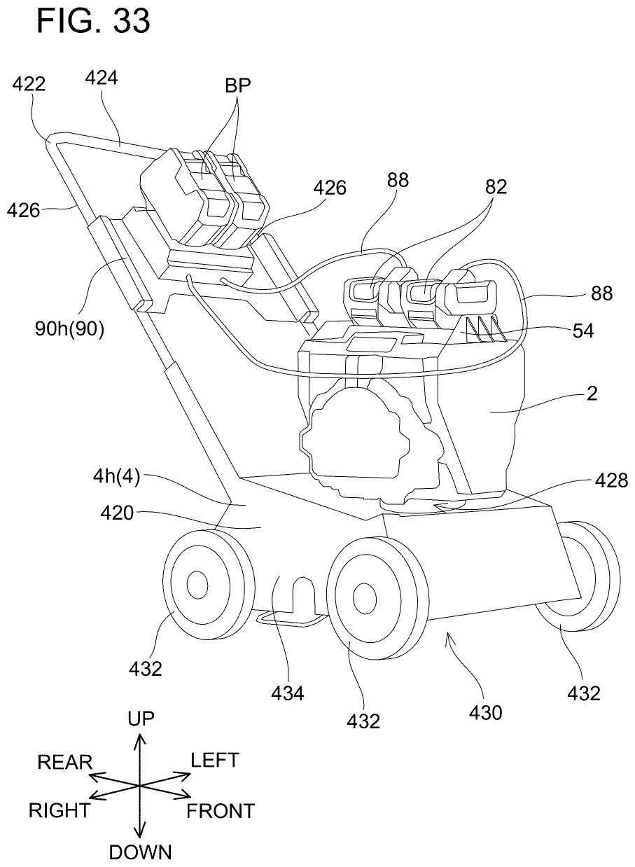

As shown in FIG. 33, a working machine according to this embodiment comprises a mower 4h and a motor unit 2. This motor unit 2 is similar to that described in the first embodiment.

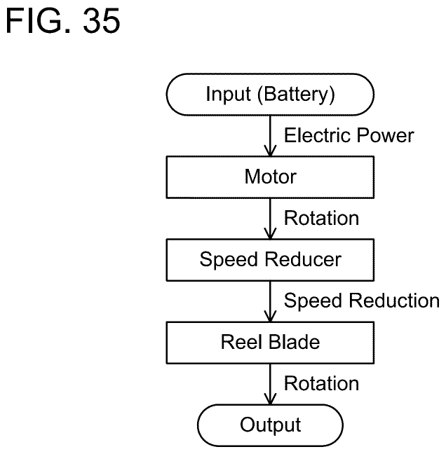

The mower 4h comprises a body 420 and a handle 422 attached to the body 420. The handle 422 comprises a grip 424 gripped by the user during use and two support pillars 426 extending between the grip 424 and the body 420. The body 420 comprises a mounting base 428 to which the motor unit 2 is attached, a reel blade 430 driven by the motor unit 2, and a housing 434 with wheels 432. The mounting base 428 is similar to the mounting base 328 (see FIG. 18) described in the fifth embodiment. Thus, the lower mounting portion 64 (see FIG. 6) of the motor unit 2 is attached to the mounting base 428. When the electric motor 70 (see FIG. 7) of the motor unit 2 operates, the reel blade 430 rotates. The mower 4h holds lawn between the rotating reel blade 430 and a fixed blade (not shown) fixed to the housing 434 to cut the lawn. FIG. 35 schematically shows a power transmission flow in the working machine according to this embodiment described above. The user can move the mower 4h by gripping the grip 424 and pushing the mower 4h with the housing 434 (i.e., the wheels 432) placed on the ground.

In this embodiment, a front-rear direction, up-down direction, and right-left direction of the mower 4h are defined based on a working orientation of the mower 4h. Specifically, a vertically up-down direction when the housing 434 (i.e., the wheels 432) is on a horizontal surface is defined as the up-down direction of the mower 4h, a direction that is perpendicular to the up-down direction and is from the grip 424 toward the body 420 is defined as the front direction, the opposite direction to the front direction is defined as the rear direction, and a direction perpendicular to the front-rear direction and the up-down direction is defined as the right-left direction.

In this embodiment, the motor unit 2 comprises a second battery receptacle 90h corresponding to the mower 4h instead of the second battery receptacle 90a (see FIG. 5) described in the first embodiment. The second battery receptacle 90h is mounted on the two support pillars 426 of the mower 4h to bridge them. The two support pillars 426 extend rearward and upward from the body 420 and connect to the grip 424. Similar to the second battery receptacle 90a in the first embodiment, the second battery receptacle 90h is configured to allow two battery packs BP to be detachably attached thereto. Each battery pack BP is attached to the second battery receptacle 90h by being slid forward and downward toward the second battery receptacle 90h. The battery pack BP is detached from the second battery receptacle 90h by being slid rearward and upward away from the second battery receptacle 90h. Thus, when attaching the battery pack BP to or detaching the battery pack BP from the second battery receptacle 90h, the user standing behind the mower 4h can handle the battery BP near the user's body. Therefore, the user standing behind the mower 4h can easily attach and detach the battery pack BP.

The adapters 82 are attached to the first battery receptacle 54 by being slid leftward toward the first battery receptacle 54. The adapters 82 are detached from the first battery receptacle 54 by being slid rightward away from the first battery receptacle 54. In this embodiment, the first battery receptacle 54 is disposed at a position easily accessible by the user (on the upper surface of the mower 4h). Thus, the user can easily attach and detach the adapters 82.

### Sixteenth Embodiment

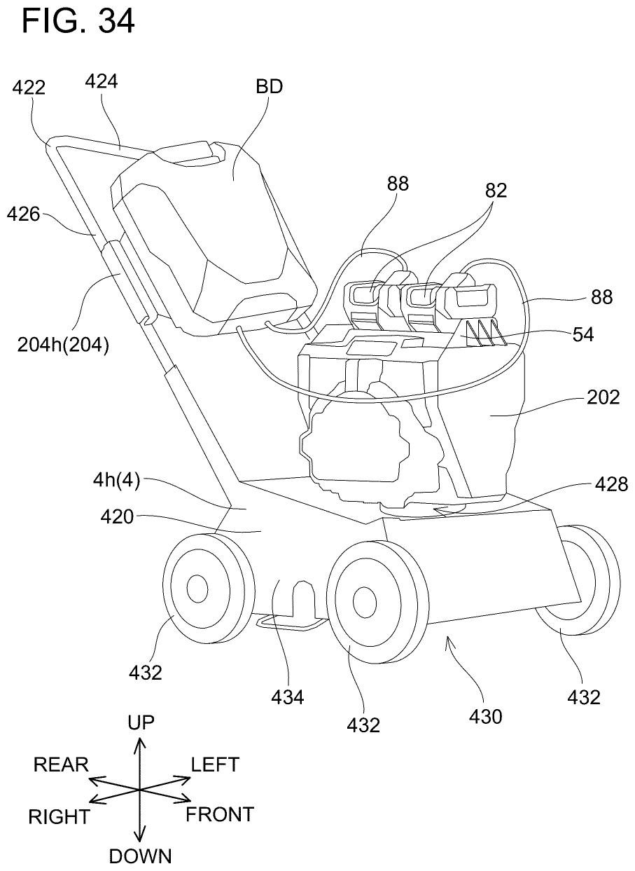

As shown in FIG. 34, a working machine according to this embodiment comprises a mower 4h and a motor unit 202. This mower 4h is similar to that described in the fifteenth embodiment and this motor unit 202 is similar to that described in the second embodiment.

In this embodiment, the motor unit 202 comprises a second battery receptacle 204h corresponding to the mower 4h instead of the second battery receptacle 204a (see FIG. 13) described in the second embodiment. The second battery receptacle 204h is mounted on the two support pillars 426 to bridge them. Similar to the second battery receptacle 204a in the second embodiment, the second battery receptacle 204h is configured to allow the battery device BD to be detachably attached thereto.

The battery device BD is attached to the second battery receptacle 204h such that the latch 262 (see FIG. 12) faces a rearward and upward direction. Thus, the latch 262 is positioned for the user standing behind the mower 4h to easily manipulate the latch 262. Therefore, the user standing behind the mower 4h can easily attach and detach the battery device BD.

The adapters 82 are attached to the first battery receptacle 54 by being slid leftward toward the first battery receptacle 54. The adapters 82 are detached from the first battery receptacle 54 by being slid rightward away from the first battery receptacle 54. In this embodiment, the first battery receptacle 54 is disposed at a position easily accessible by the user (on the upper surface of the mower 4h). Thus, the user can easily attach and detach the adapters 82.

### Seventeenth Embodiment

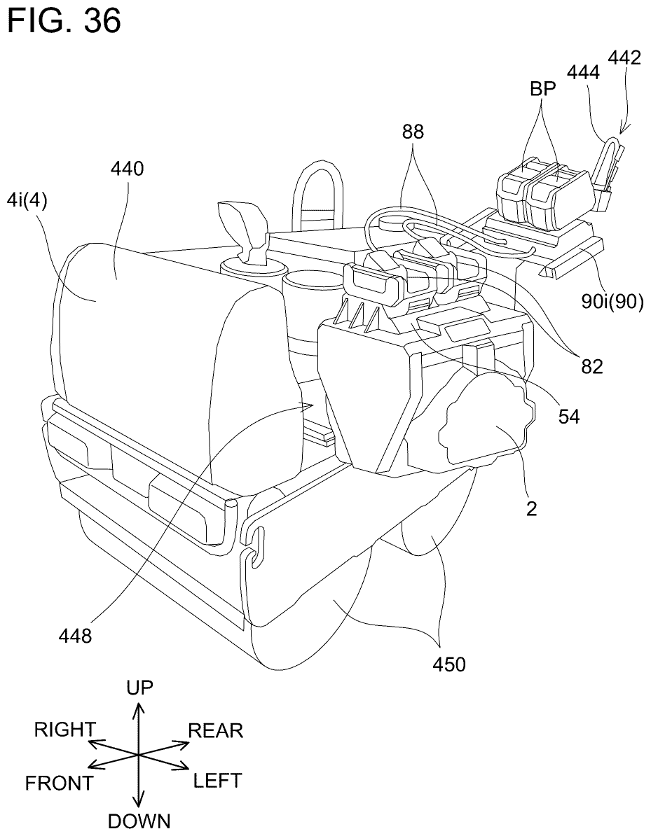

As shown in FIG. 36, a working machine according to this embodiment comprises a compaction roller 4i and a motor unit 2. This motor unit 2 is similar to that described in the first embodiment.

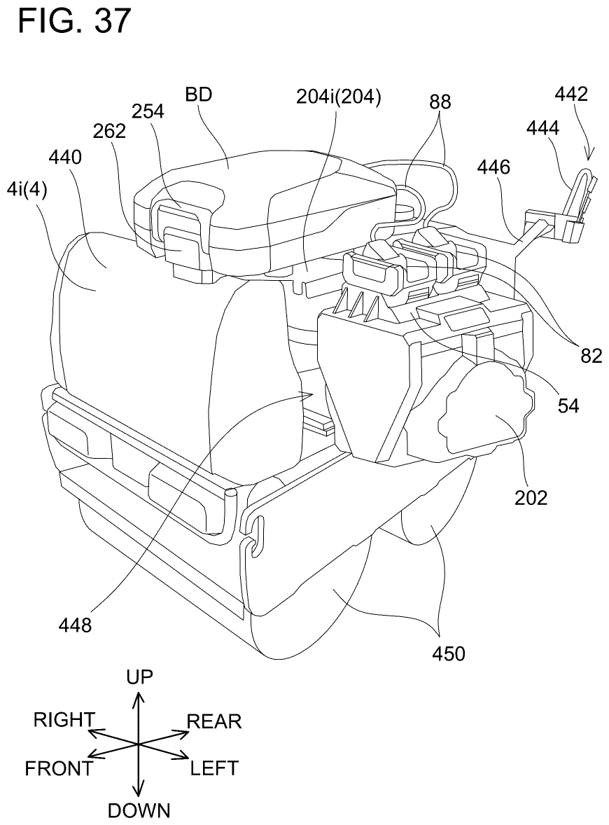

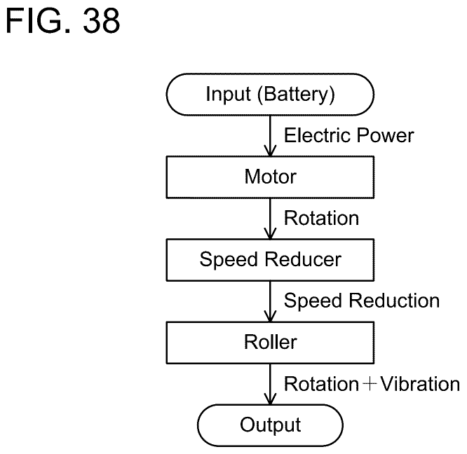

The compaction roller 4i comprises a body 440 and a handle 442 attached to the body 440. The handle 442 comprises a grip 444 gripped by the user during use and a support pillar 446 (see FIG. 37) extending between the grip 444 and the body 440. The body 440 comprises a mounting base 448 to which the motor unit 2 is attached and rollers 450 driven by the motor unit 2. The mounting base 448 is similar to the mounting base 12 described in the first embodiment. Thus, the front mounting portion 56 (see FIG. 6) of the motor unit 2 is attached to the mounting base 448. When the electric motor 70 (see FIG. 7) of the motor unit 2 operates, the rollers 450 rotate and vibration exciter mechanisms (e.g., eccentric weights) housed in the rollers 450 operate. The compaction roller 4i moves on the ground while pressing the vibrating rollers 450 against the ground. The compaction roller 4i compacts the ground in this way. FIG. 38 schematically shows a power transmission flow in the working machine according to this embodiment described above.

In this embodiment, a front-rear direction, up-down direction, and right-left direction of the compaction roller 4i are defined based on a working orientation of the compaction roller 4i. Specifically, a vertically up-down direction when the rollers 450 are on a horizontal surface is defined as the up-down direction of the compaction roller 4i, a direction that is perpendicular to the up-down direction and is from the grip 444 toward the body 440 is defined as the front direction, the opposite direction to the front direction is defined as the rear direction, and a direction perpendicular to the front-rear direction and the up-down direction is defined as the right-left direction.

In this embodiment, the motor unit 2 comprises a second battery receptacle 90i corresponding to the compaction roller 4i instead of the second battery receptacle 90a (see FIG. 5) described in the first embodiment. The second battery receptacle 90i is mounted on the support pillar 446 of the compaction roller 4i. The support pillar 446 extends rearward and upward from the body 440 and connects to the grip 444. Similar to the second battery receptacle 90a in the first embodiment, the second battery receptacle 90i is configured to allow two battery packs BP to be detachably attached there to. Each battery pack BP is attached to the second battery receptacle 90i by being slid forward and downward toward the second battery receptacle 90i. The battery pack BP is detached from the second battery receptacle 90i by being slid rearward and upward away from the second battery receptacle 90i. Thus, when attaching the battery pack BP to or detaching the battery pack BP from the second battery receptacle 90i, the user standing behind the compaction roller 4i can handle the battery pack BP neat the user's body. Therefore, the user standing behind the compaction roller 4i can easily attach and detach the battery pack BP.

The adapters 82 are attached to the first battery receptacle 54 by being slid rightward toward the first battery receptacle 54. The adapters 82 are detached from the first battery receptacle 54 by being slid leftward away from the first battery receptacle 54. In this embodiment, the first battery receptacle 54 is disposed at a position easily accessible by the user (on the upper surface of the compaction roller 4i). Thus, the user can easily attach and detach the adapters 82.

### Eighteenth Embodiment

As shown in FIG. 37, a working machine according to this embodiment comprises a compaction roller 4i and a motor unit 202. This compaction roller 4i is similar to that described in the seventeenth embodiment and this motor unit 202 is similar to that described in the second embodiment.

In this embodiment, the motor unit 202 comprises a second battery receptacle 204i corresponding to the compaction roller 4i instead of the second battery receptacle 204a (see FIG. 13) described in the second embodiment. The second battery receptacle 204i is mounted on the upper surface of the body 440. Similar to the second battery receptacle 204a in the second embodiment, the second battery receptacle 204i is configured to allow the battery device BD to be detachably attached thereto. The battery device BD is attached to the second battery receptacle 204i such that the latch 262 faces forward. In this embodiment, the second battery receptacle 204i is disposed at a position easily accessible by the user (on the upper surface of the compaction roller 4i). Thus, the user can easily attach and detach the battery device BD.

The adapters 82 are attached to the first battery receptacle 54 by being slid rightward toward the first battery receptacle 54. The adapters 82 are detached from the first battery receptacle 54 by being slid leftward away from the first battery receptacle 54. In this embodiment, the first battery receptacle 54 is disposed at a position easily accessible by the user (on the upper surface of the compaction roller 4i). Thus, the user can easily attach and detach the adapters 82.

In the disclosure herein, the second battery receptacles 90a, 90b, 90c, 90d, 90e, 90f, 90g, 90h, and 90i may be collectively referred to as “second battery receptacle 90”. Further, the second battery receptacles 204a, 204b, 204c, 204d, 204e, 204f, 204g, 204h, and 204i may be collectively referred to as “second battery receptacle 204”.

### Variants

(FIGS. 5 and 10) The number of battery packs BP attachable to the first battery receptacle 54 may be one, or three or more. Similarly, the number of battery packs BP attachable to the second battery receptacle 90 may be one, or three or more.

(FIG. 8) The adapters 82 may be attached to the first battery receptacle 54 in an undetachable manner. That is, after the adapters 82 have been attached to the first battery receptacle 54, the detachment of the adapters 82 may be prohibited.

(FIG. 7 etc.) The motor unit 2 may not comprise the first battery receptacle 54 nor the adapters 82. In this case, each cable 88 may connect the housing 50 to the second battery receptacle 90 instead of connecting the adapter 82 to the second battery receptacle 90. The power in the battery packs BP attached to the second battery receptacle 90 may be supplied to the electric motor 70 within the housing 50 through the second battery receptacle 90 and the cables 88.

(FIG. 7 etc.) The motor unit 202 may not comprise the first battery receptacle 54 nor the adapters 82. In this case, the cables 88 may connect the housing 50 to the second battery receptacle 204 instead of connecting the adapters 82 to the second battery receptacle 204. The power in the battery device BD attached to the second battery receptacle 204 may be supplied to the electric motor 70 within the housing 50 through the second battery receptacle 204 and the cables 88.

(FIG. 7 etc.) The control circuit board 74 may be disposed outside the housing 50. For example, the control circuit board 74 may be disposed in the working unit 4. The control circuit board 74 may be integrated with the second battery receptacle 90 (or 204).

(FIG. 6 etc.) The motor unit 2 (or 202) may not comprise one of the front contact surface 58 and the lower contact surface 66.

(FIG. 9 etc.) The motor unit 2 may not comprise the cover 96.

(FIG. 10 etc.) The second battery receptacle 90 may be divided into a first portion to which one battery pack BP is attached and a second portion to which another battery pack BP is attached. The first and second portions may be disposed separately on the handle of the working unit 4.

(FIGS. 1, 11 etc.) The second battery receptacle 90 (or 204) may be disposed at a position (e.g., on a side surface of the working unit 4) other than a position on the handle of the working unit 4 and a position on the upper surface of the working unit 4. Thus, the battery packs BP (or the battery device BD) may be attached at a position (e.g., on a side surface of the working unit 4) other than a position on the handle of the working unit 4 and a position on the upper surface of the working unit 4.

(FIGS. 5, 10 etc.) The first battery receptacle 54 and the second battery receptacle 90 may not comprise the members having the common shape to each other.

(FIGS. 1, 11 etc.) The length of the cables 88 may be less than 100 mm or greater than 2000 mm.

### Features of Motor Unit 2

In one or more embodiments, the motor unit 2 is configured to be detachably attached to each of the working units 4 of multiple types to drive the working unit 4. The motor unit 2 comprises the output shaft 52 configured to be connected to the working unit 4; the electric motor 70 configured to rotate the output shaft 52; the housing 50 that houses the electric motor 70; the first battery receptacle 54 disposed on the housing 50 and configured to allow the battery pack BP (an example of first battery) to be detachably attached thereto; the second battery receptacle 90 disposed on the working unit 4 and configured to allow the battery pack BP (an example of second battery) to be detachably attached thereto; the adapter 82 configured to be attached to the first battery receptacle 54 in place of the battery pack BP; the cable 88 extending from the adapter 82 and configured to connect to the second battery receptacle 90; and the control circuit board 74 configured to control the output of the electric motor 70. When the battery pack BP is attached to the first battery receptacle 54, power is supplied from the battery pack BP to the electric motor 70 via the first battery receptacle 54. When the adapter 82 is attached to the first battery receptacle 54 and the battery pack BP is attached to the second battery receptacle 90, power is supplied from the battery pack BP to the electric motor 70 via the cable 88, the adapter 82, and the first battery receptacle 54.

In the configuration above, the battery pack BP can be attached to the second battery receptacle 90 disposed on the working unit 4. Attaching the battery pack BP to the second battery receptacle 90 reduces the transmission of vibrations from the housing 50 to the battery pack BP, compared to attaching the battery pack BP to the housing 50.

In one or more embodiments, the motor unit 2 is configured to be detachably attached to each of the working units 4 of multiple types to drive the working unit 4. The motor unit 2 comprises the output shaft 52 configured to be connected to the working unit 4; the electric motor 70 configured to rotate the output shaft 52; the housing 50 that houses the electric motor 70; the second battery receptacle 90 (an example of battery receptacle) disposed on the working unit 4 and configured to allow the battery pack BP (an example of battery) to be detachably attached thereto; the cable 88 extending from the housing 50 and configured to connect to the second battery receptacle 90; and the control circuit board 74 disposed in the housing 50 and configured to control the output of the electric motor 70. When the battery pack BP is attached to the second battery receptacle 90, power is supplied from the battery pack BP to the electric motor 70 via the cable 88.

In the configuration above, the battery pack BP can be attached to the second battery receptacle 90 disposed on the working unit 4. Attaching the battery pack BP to the second battery receptacle 90 reduces the transmission of vibrations from the housing 50 to the battery pack BP, compared to attaching the battery pack BP to the housing 50.

In one or more embodiments, the control circuit board 74 is disposed in the housing 50.

The fan 72 for cooling the electric motor 70 is disposed in the housing 50. In the configuration above, the control circuit board 74 as well as the electric motor 70 can be cooled with cooling airflow generated by the fan 72. Thus, another fan 72 for cooling the control circuit board 74 is not required to be disposed in the motor unit 2, which allows for simplification of the configuration of the motor unit 2.

In one or more embodiments, the motor unit 2 further comprises the lower contact surface 66 (an example of first surface) parallel to the axial direction of the output shaft 52 and the front contact surface 58 (an example of second surface) perpendicular to the axial direction of the output shaft 52. The motor unit 2 is configured to be fixed to the working unit 4 with at least one of the lower contact surface 66 and the front contact surface 58 in contact with the working unit 4.

In the configuration above, the motor unit 2 can be attached to the working units 4 in various orientations (e.g., with the lower contact surface 66 in contact with the working unit 4, with the front contact surface 58 in contact with the working unit 4, etc.). This leads to an increase in the number of types of working units 4 to which the motor unit 2 is attachable.

In one or more embodiments, the battery pack BP is capable of supplying power to an electric device (e.g., the electric tool T) different from the motor unit 2 when the battery pack BP is detached from the motor unit 2 and attached to the electric device.

The above configuration allows the battery pack BP to be used not only in the motor unit 2 but also in the electric device different from the motor unit 2.

In one or more embodiments, the second battery receptacle 90 may be configured to allow a plurality of battery packs BP to be detachably attached thereto.

Since the plurality of battery packs BP can be attached to the second battery receptacle 90 in the configuration above, the electric motor 70 can operate using the power from the plurality of battery packs BP. This allows for an increase in the output of the electric motor 70, for example, compared to the electric motor 70 operating using the power from a single battery pack BP. Thus, the motor unit 2 can be used with working units 4 that require high outputs. That is, the above configuration allows for an increase in the number of types of working units 4 to which the motor unit is applicable.

In one or more embodiments, the motor unit 2 further comprises the cover 96 that covers the battery pack BP attached to the second battery receptacle 90.

The configuration above protects the battery pack BP attached to the second battery receptacle 90 against external water and dust.

In one or more embodiments, the working units 4 comprise the handles 10, 302, 322, 342, 362, 382, 422, 442 including a grip configured to be grasped by a user. The second battery receptacle 90 is disposed on any of the handles 10, 302, 322, 342, 362, 382, 422, 442.

In the configuration above, the second battery receptacle 90 is disposed on any of the handles 10, 302, 322, 342, 362, 382, 422, 442. The handles 10, 302, 322, 342, 362, 382, 422, 442 may be configured to reduce transmission of vibrations from the bodies of the working units 4 in order not to make the user gripping the grip uncomfortable. Thus, attaching the battery pack BP to the second battery receptacle 90 reduces transmission of vibrations from the body of the working unit 4 to the battery pack BP. Further, in the configuration above, the second battery receptacle 90 is disposed at a position easily accessible by the user. This allows the user to easily attach the battery pack BP to and detach the battery pack BP from the second battery receptacle 90.

In one or more embodiments, the second battery receptacle 90 is on the upper surface of the working unit 4 when the working unit 4 is in its working orientation.

In the configuration above, the second battery receptacle 90 is at a position easily accessible by the user when the working unit 4 is in its working orientation. This allows the user to easily attach the battery pack BP to and detach the battery pack BP from the second battery receptacle 90.

In one or more embodiments, the first battery receptacle 54 and the second battery receptacle 90 comprise the connection terminals 46 (an example of common member), respectively, and the connection terminals 46 have a common shape to each other.

The configuration above allows common components to be used in the first and second battery receptacles 54, 90. This allows for a reduction in the manufacturing cost of the motor unit 2.

In one or more embodiments, the length of the cable 88 is in a range of 100 mm to 2000 mm.

The cable 88 extends between the first battery receptacle 54 disposed on the housing 50 and the second battery receptacle 90 disposed on the working unit 4. If the length of the cable 88 were too long relative to the distance between the first and second battery receptacles 54, 90, the cable 88 would sag too much and get in the way during use. Although the distance between the first and second battery receptacles 54, 90 differs depending on the type of working unit 4, it is generally expected to be in a range of 50 mm to 1500 mm. In the configuration above, the length of the cable 88 is slightly larger than the expected distance between the first and second battery receptacles 54, 90. Thus, the configuration above prevents the cable 88 from sagging too much and thus prevents the cable 88 from getting in the way during use.

In one or more embodiments, the adapter 82 is configured to be detachably attached to the first battery receptacle 54.

If the adapter 82 were configured to be attached to the first battery receptacle 54 in an undetachable manner, the adapter 82 cannot be detached from the first battery receptacle 54 once attached thereto. However, the user may wish to detach the adapter 82 from the first battery receptacle 54 after having attached it to the first battery receptacle 54. For example, the user may wish so when wishing to attach the battery pack BP to the first battery receptacle 54 instead of the adapter 82. In the configuration above, the adapter 82 is detachably attached to the first battery receptacle 54. Thus, the adapter 82 can be detached from the first battery receptacle 54 after having been attached to the first battery receptacle 54. Therefore, the battery pack BP can be attached to the first battery receptacle 54 instead of the adapter 82.

In one or more embodiments, the working unit 4 functions as the rammer 4a configured to ram the ground. The working unit 4 comprises the handle 10 including the grips 20, 22, 24 configured to be grasped by a user. The second battery receptacle 90 is disposed on the handle 10.

In the configuration above, the battery pack BP is attached to the handle 10 of the rammer 4a. This reduces transmission of vibrations from the housing 50 to the battery pack BP and also reduces transmission of vibrations from the working part 6 of the rammer 4a (an example of body of the rammer) to the battery pack BP.

In one or more embodiments, the working unit 4 functions as the plate compactor 4b configured to compact the ground. The working unit 4 comprises the handle 302 including the grip 304 configured to be grasped by a user. The second battery receptacle 90 is disposed on the handle 302.

In the configuration above, the battery pack BP is attached to the handle 302 of the plate compactor 4b. This reduces transmission of vibrations from the housing 50 to the battery pack BP and also reduces transmission of vibrations from the body 300 of the plate compactor 4b to the battery pack BP.

In one or more embodiments, the working unit 4 functions as the trowel 4c configured to level a concrete surface. The working unit 4 comprises the handle 322 including the grip 324 configured to be grasped by a user. The second battery receptacle 90 is disposed on the handle 322.

In the configuration above, the battery pack BP is attached to the handle 322 of the trowel 4c. This reduces transmission of vibrations from the housing 50 to the battery pack BP and also reduces transmission of vibrations from the body 320 of the trowel 4c to the battery pack BP.

In one or more embodiments, the working unit 4 functions as the concrete mixer 4d configured to mix concrete. The working unit 4 comprises the handle 342 including the grip 344 configured to be grasped by a user. The second battery receptacle 90 is disposed on the handle 342.

In the configuration above, the battery pack BP is attached to the handle 342 of the concrete mixer 4d. This reduces transmission of vibrations from the housing 50 to the battery pack BP and also reduces transmission of vibrations from the body 340 of the concrete mixer 4d to the battery pack BP.

In one or more embodiments, the working unit 4 functions as the concrete saw 4e configured to make a cut in concrete. The working unit 4 comprises the handle 362 including the grip 364 configured to be grasped by a user. The second battery receptacle 90 is disposed on the handle 362.

In the configuration above, the battery pack BP is attached to the handle 362 of the concrete saw 4e. This reduces transmission of vibrations from the housing 50 to the battery pack BP and also reduces transmission of vibrations from the body 360 of the concrete saw 4e to the battery pack BP.

In one or more embodiments, the working unit 4 functions as the pressure washer 4f (or the sprayer 4g) (an example of injector) configured to boost the pressure of a liquid and inject the liquid. The second battery receptacle 90 is on the upper surface of the working unit 4 when the working unit 4 is in its working orientation.

In the configuration above, the battery pack BP is attached to the upper surface of the pressure washer 4f (or the sprayer 4g). This reduces transmission of vibrations from the housing 50 to the battery pack BP.

In one or more embodiments, the working unit 4 functions as the mower 4h. The working unit 4 comprises the handle 422 including the grip 424 configured to be grasped by a user. The second battery receptacle 90 is disposed on the handle 422.

In the configuration above, the battery pack BP is attached to the handle 422 of the mower 4h. This reduces transmission of vibrations from the housing 50 to the battery pack BP and also reduces transmission of vibrations from the body 420 of the mower 4h to the battery pack BP.

In one or more embodiments, a working machine comprises a working unit 4 and a motor unit 2 configured to be detachably attached to the working unit 4 to drive the working unit 4 with power from the motor unit 2.

The configuration above provides the working machine that reduces transmission of vibrations from the housing 50 to the battery pack BP.

### Features of Motor Unit 202

In one or more embodiments, the motor unit 202 is configured to be detachably attached to each of the working units 4 of multiple types to drive the working unit 4. The motor unit 202 comprises the output shaft 52 configured to be connected to the working unit 4; the electric motor 70 configured to rotate the output shaft 52; the housing 50 that houses the electric motor 70; the first battery receptacle 54 disposed on the housing 50 and configured to allow the battery pack BP (an example of first battery) to be detachably attached thereto; the second battery receptacle 204 disposed on the working unit 4 and configured to allow the battery device BD (an example of second battery) to be detachably attached thereto; the adapter 82 configured to be attached to the first battery receptacle 54 in place of the battery pack BP; the cable 88 extending from the adapter 82 and configured to connect to the second battery receptacle 204; and the control circuit board 74 configured to control the output of the electric motor 70. When the battery pack BP is attached to the first battery receptacle 54, power is supplied from the battery pack BP to the electric motor 70 via the first battery receptacle 54. When the adapter 82 is attached to the first battery receptacle 54 and the battery device BD is attached to the second battery receptacle 204, power is supplied from the battery device BD to the electric motor 70 via the cable 88, the adapter 82, and the first battery receptacle 54.

In the configuration above, the battery device BD can be attached to the second battery receptacle 204 disposed on the working unit 4. Attaching the battery device BD to the second battery receptacle 204 reduces the transmission of vibrations from the housing 50 to the battery device BD, compared to attaching the battery device BD to the housing 50.

In one or more embodiments, the motor unit 202 is configured to be detachably attached to each of the working units 4 of multiple types to drive the working unit 4. The motor unit 202 comprises the output shaft 52 configured to be connected to the working unit 4; the electric motor 70 configured to rotate the output shaft 52; the housing 50 that houses the electric motor 70; the second battery receptacle 204 (an example of battery receptacle) disposed on the working unit 4 and configured to allow the battery device BD (an example of battery) to be detachably attached thereto; the cable 88 extending from the housing 50 and configured to connect to the second battery receptacle 204; and the control circuit board 74 disposed in the housing 50 and configured to control the output of the electric motor 70. When the battery device BD is attached to the second battery receptacle 204, power is supplied from the battery device BD to the electric motor 70 via the cable 88.

In the configuration above, the battery device BD can be attached to the second battery receptacle 204 disposed on the working unit 4. Attaching the battery device BD to the second battery receptacle 204 reduces the transmission of vibrations from the housing 50 to the battery device BD, compared to attaching the battery device BD to the housing 50.

In one or more embodiments, the control circuit board 74 is disposed in the housing 50.

The fan 72 for cooling the electric motor 70 is disposed in the housing 50. In the configuration above, the control circuit board 74 as well as the electric motor 70 can be cooled with cooling airflow generated by the fan 72. Thus, another fan 72 for cooling the control circuit board 74 is not required to be disposed in the motor unit 202, which allows for simplification of the configuration of the motor unit 202.

In one or more embodiments, the motor unit 202 further comprises the lower contact surface 66 (an example of first surface) parallel to the axial direction of the output shaft 52 and the front contact surface 58 (an example of second surface) perpendicular to the axial direction of the output shaft 52. The motor unit 202 is configured to be fixed to the working unit 4 with at least one of the lower contact surface 66 and the front contact surface 58 in contact with the working unit 4.

In the configuration above, the motor unit 202 can be attached to the working units 4 in various orientations (e.g., with the lower contact surface 66 in contact with the working unit 4, with the front contact surface 58 in contact with the working unit 4, etc.). This leads to an increase in the number of types of working units 4 to which the motor unit 2 is attachable.

In one or more embodiments, the working units 4 comprise the handles 10, 302, 322, 342, 362, 382, 422, 442 including a grip configured to be grasped by a user. The second battery receptacle 204 is disposed on any of the handles 10, 302, 322, 342, 362, 382, 422, 442.

In the configuration above, the second battery receptacle 204 is disposed on any of the handles 10, 302, 322, 342, 362, 382, 422, 442. The handles 10, 302, 322, 342, 362, 382, 422, 442 may be configured to reduce transmission of vibrations from the bodies of the working units 4 in order not to make the user gripping the grip uncomfortable. Thus, attaching the battery device BD to the second battery receptacle 204 reduces transmission of vibrations from the body of the working unit 4 to the battery device BD. Further, in the configuration above, the second battery receptacle 204 is disposed at a position easily accessible by the user. This allows the user to easily attach the battery device BD to and detach the battery device BD from the second battery receptacle 204.

In one or more embodiments, the second battery receptacle 204 is on the upper surface of the working unit 4 when the working unit 4 is in its working orientation.

In the configuration above, the second battery receptacle 204 is at a position easily accessible by the user when the working unit 4 is in its working orientation. This allows the user to easily attach the battery device BD to and detach the battery device BD from the second battery receptacle 204.

In one or more embodiments, the length of the cable 88 is in a range of 100 mm to 2000 mm.

The cable 88 extends between the first battery receptacle 54 disposed on the housing 50 and the second battery receptacle 204 disposed on the working unit 4. If the length of the cable 88 were too long relative to the distance between the first and second battery receptacles 54, 204, the cable 88 would sag too much and get in the way during use. Although the distance between the first and second battery receptacles 54, 204 differs depending on the type of working unit 4, it is generally expected to be in a range of 50 mm to 1500 mm. In the configuration above, the length of the cable 88 is slightly larger than the expected distance between the first and second battery receptacles 54, 204. Thus, the configuration above prevents the cable 88 from sagging too much and thus prevents the cable 88 from getting in the way during use.

In one or more embodiments, the adapter 82 is configured to be detachably attached to the first battery receptacle 54.

If the adapter 82 were configured to be attached to the first battery receptacle 54 in an undetachable manner, the adapter 82 cannot be detached from the first battery receptacle 54 once attached thereto. However, the user may wish to detach the adapter 82 from the first battery receptacle 54 after having attached it to the first battery receptacle 54. For example, the user may wish so when wishing to attach the battery pack BP to the first battery receptacle 54 instead of the adapter 82. In the configuration above, the adapter 82 is detachably attached to the first battery receptacle 54. Thus, the adapter 82 can be detached from the first battery receptacle 54 after having been attached to the first battery receptacle 54. Therefore, the battery pack BP can be attached to the first battery receptacle 54 instead of the adapter 82.

In one or more embodiments, the working unit 4 functions as the rammer 4a configured to ram the ground. The working unit 4 comprises the handle 10 including the grips 20, 22, 24 configured to be grasped by a user. The second battery receptacle 204 is disposed on the handle 10.

In the configuration above, the battery device BD is attached to the handle 10 of the rammer 4a. This reduces transmission of vibrations from the housing 50 to the battery device BD and also reduces transmission of vibrations from the working part 6 of the rammer 4a (an example of body of the rammer) to the battery device BD.

In one or more embodiments, the working unit 4 functions as the plate compactor 4b configured to compact the ground. The working unit 4 comprises the handle 302 including the grip 304 configured to be grasped by a user. The second battery receptacle 204 is disposed on the handle 302.

In the configuration above, the battery device BD is attached to the handle 302 of the plate compactor 4b. This reduces transmission of vibrations from the housing 50 to the battery device BD and also reduces transmission of vibrations from the body 300 of the plate compactor 4b to the battery device BD.

In one or more embodiments, the working unit 4 functions as the trowel 4c configured to level a concrete surface. The working unit 4 comprises the handle 322 including the grip 324 configured to be grasped by a user. The second battery receptacle 204 is disposed on the handle 322.

In the configuration above, the battery device BD is attached to the handle 322 of the trowel 4c. This reduces transmission of vibrations from the housing 50 to the battery device BD and also reduces transmission of vibrations from the body 320 of the trowel 4c to the battery device BD.

In one or more embodiments, the working unit 4 functions as the concrete mixer 4d configured to mix concrete. The working unit 4 comprises the handle 342 including the grip 344 configured to be grasped by a user. The second battery receptacle 204 is disposed on the handle 342.

In the configuration above, the battery device BD is attached to the handle 342 of the concrete mixer 4d. This reduces transmission of vibrations from the housing 50 to the battery device BD and also reduces transmission of vibrations from the body 340 of the concrete mixer 4d to the battery device BD.

In one or more embodiments, the working unit 4 functions as the concrete saw 4e configured to make a cut in concrete. The working unit 4 comprises the handle 362 including the grip 364 configured to be grasped by a user. The second battery receptacle 204 is disposed on the handle 362.

In the configuration above, the battery device BD is attached to the handle 362 of the concrete saw 4e. This reduces transmission of vibrations from the housing 50 to the battery device BD and also reduces transmission of vibrations from the body 360 of the concrete saw 4e to the battery device BD.

In one or more embodiments, the working unit 4 functions as the pressure washer 4f (or the sprayer 4g) (an example of injector) configured to boost the pressure of a liquid and inject the liquid. The second battery receptacle 204 is on the upper surface of the working unit 4 when the working unit 4 is in its working orientation.

In the configuration above, the battery device BD is attached to the upper surface of the pressure washer 4f (or the sprayer 4g). This reduces transmission of vibrations from the housing 50 to the battery device BD.

In one or more embodiments, the working unit 4 functions as the mower 4h. The working unit 4 comprises the handle 422 including the grip 424 configured to be grasped by a user. The second battery receptacle 204 is disposed on the handle 422.

In the configuration above, the battery device BD is attached to the handle 422 of the mower 4h. This reduces transmission of vibrations from the housing 50 to the battery device BD and also reduces transmission of vibrations from the body 420 of the mower 4h to the battery device BD.

In one or more embodiments, a working machine comprises a working unit 4 and a motor unit 202 configured to be detachably attached to the working unit 4 to drive the working unit 4 with power from the motor unit 202.

The configuration above provides the working machine that reduces transmission of vibrations from the housing 50 to the battery device BD.

What is claimed is:

1. A motor unit configured to be detachably attached to each of working units of multiple types to drive the working unit to which the motor unit is attached, the motor unit comprising:
an output shaft configured to be connected to the working unit;
an electric motor configured to rotate the output shaft;
a housing that houses the electric motor;
a first battery receptacle disposed on the housing and configured to allow a first battery to be detachably attached thereto;
a second battery receptacle disposed on the working unit and configured to allow a second battery to be detachably attached thereto;
an adapter configured to be attached to the first battery receptacle in place of the first battery;
a cable extending from the adapter and configured to connect to either the second battery receptacle or the second battery; and
a control circuit board configured to control an output of the electric motor,
wherein
when the first battery is attached to the first battery receptacle, power is supplied from the first battery to the electric motor via the first battery receptacle, and
when the adapter is attached to the first battery receptacle and the second battery is attached to the second battery receptacle, power is supplied from the second battery to the electric motor via the cable, the adapter, and the first battery receptacle.

2. The motor unit according to claim 1, wherein the control circuit board is disposed in the housing.

3. The motor unit according to claim 1, further comprising:
a first surface parallel to an axial direction of the output shaft; and
a second surface perpendicular to the axial direction of the output shaft,
wherein the motor unit is configured to be fixed to the working unit with at least one of the first surface and the second surface in contact with the working unit.

4. The motor unit according to claim 1, wherein at least one of the first battery and the second battery is capable of supplying power to an electric device different from the motor unit when the at least one of the first battery and the second battery is detached from the motor unit and attached to the electric device.

5. The motor unit according to claim 1, wherein
the second battery comprises a plurality of second batteries,
the plurality of second batteries includes a plurality of battery packs, and
the second battery receptacle is configured to allow the plurality of battery packs to be detachably attached thereto.

6. The motor unit according to claim 1, wherein
the second battery includes a battery pack, and
the motor unit further comprises a cover that covers the battery pack attached to the second battery receptacle.

7. The motor unit according to claim 1, wherein
the working unit comprises a handle including a grip configured to be grasped by a user, and
the second battery receptacle is disposed on the handle.

8. The motor unit according to claim 1, wherein the second battery receptacle is on an upper surface of the working unit when the working unit is in a working orientation.

9. The motor unit according to claim 1, wherein the first battery receptacle and the second battery receptacle comprise common members, respectively, and the common members have a common shape to each other.

10. The motor unit according to claim 1, wherein a length of the cable is in a range of 100 mm to 2000 mm.

11. The motor unit according to claim 1, wherein the adapter is configured to be detachably attached to the first battery receptacle.

12. The motor unit according to claim 1, wherein
the working unit functions as a ground ramming device configured to ram a ground,
the working unit comprises a handle including a grip configured to be grasped by a user, and
the second battery receptacle is disposed on the handle.

13. The motor unit according to claim 1, wherein
the working unit functions as a trowel configured to level a concrete surface,
the working unit comprises a handle including a grip configured to be grasped by a user, and
the second battery receptacle is disposed on the handle.

14. The motor unit according to claim 1, wherein
the working unit functions as a concrete mixer configured to mix concrete,
the working unit comprises a handle including a grip configured to be grasped by a user, and
the second battery receptacle is disposed on the handle.

15. The motor unit according to claim 1, wherein
the working unit functions as a concrete saw configured to cut into concrete,
the working unit comprises a handle including a grip configured to be grasped by a user, and
the second battery receptacle is disposed on the handle.

16. The motor unit according to claim 1, wherein
the working unit functions as an injector configured to boost a pressure of a liquid and inject the liquid, and
the second battery receptacle is on an upper surface of the working unit when the working unit is in a working orientation.

17. The motor unit according to claim 1, wherein
the working unit functions as a mower,
the working unit comprises a handle including a grip configured to be grasped by a user, and
the second battery receptacle is disposed on the handle.

18. A working machine comprising:
a working unit; and
a motor unit configured to be detachably attached to the working unit to drive the working unit,
wherein
the motor unit comprises:
an output shaft configured to be connected to the working unit;
an electric motor configured to rotate the output shaft;
a housing that houses the electric motor;
a first battery receptacle disposed on the housing and configured to allow a first battery to be detachably attached thereto;
a second battery receptacle disposed on the working unit and configured to allow a second battery to be detachably attached thereto;
an adapter configured to be attached to the first battery receptacle in place of the first battery;
a cable extending from the adapter and configured to connect to either the second battery receptacle or the second battery; and
a control circuit board configured to control an output of the electric motor,
wherein
when the first battery is attached to the first battery receptacle, power is supplied from the first battery to the electric motor via the first battery receptacle, and
when the adapter is attached to the first battery receptacle and the second battery is attached to the second battery receptacle, power is supplied from the second battery to the electric motor via the cable, the adapter, and the first battery receptacle.

19. A motor unit configured to be detachably attached to each of working units of multiple types to drive the working unit to which the motor unit is attached, the motor unit comprising:
an output shaft configured to be connected to the working unit;
an electric motor configured to rotate the output shaft;
a housing that houses the electric motor;
a battery receptacle disposed on the working unit and configured to allow a battery to be detachably attached thereto;
a cable extending from the housing and configured to connect to either the battery receptacle or the battery; and
a control circuit board housed within the housing and configured to control an output of the electric motor,
wherein
when the battery is attached to the battery receptacle, power is supplied from the battery to the electric motor via the cable.

20. The motor unit according to claim 2, further comprising:
a first surface parallel to an axial direction of the output shaft; and
a second surface perpendicular to the axial direction of the output shaft,
wherein
the motor unit is configured to be fixed to the working unit with at least one of the first surface and the second surface in contact with the working unit,
at least one of the first battery and the second battery is configured to supply power to an electric device different from the motor unit when the at least one of the first battery and the second battery is detached from the motor unit and attached to the electric device,
the second battery comprises a plurality of second batteries,
the plurality of second batteries includes a plurality of battery packs,
the second battery receptacle is configured to have the plurality of battery packs detachably attached thereto,
the motor unit further comprises a cover that covers the plurality of battery packs attached to the second battery receptacle,
the working unit comprises a handle including a grip configured to be grasped by a user,
the second battery receptacle is disposed on the handle,
the first battery receptacle and the second battery receptacle comprise common members, respectively, and the common members have a common shape to each other,
a length of the cable is in a range of 100 mm to 2000 mm, and
the adapter is configured to be detachably attached to the first battery receptacle.
